(19) United States
(12) Patent Application Publication
(10) Pub. No.: US 2002/0128907 A1
(43) Pub. Date: Sep. 12, 2002

(54) Information delivery scheme and advertisement providing scheme using social filtering technique

(76) Inventors: Motoi Sato, Tokyo (JP); Takeshi Motohashi, Tokyo (JP); Yuuichirou Oshikawa, Tokorozawa-shi (JP); Yuusuke Ichikawa, Yokohama-shi (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/876,666

(22) Filed: Jun. 7, 2001

(30) Foreign Application Priority Data
Jun. 7, 2000 (JP) P2000-171170
Jun. 8, 2000 (JP) P2000-172637
Jun. 30, 2000 (JP) P2000-199789
Jun. 30, 2000 (JP) P2000-200212

(51) Int. Cl. G06F 17/60

(52) U.S. Cl. 705/14; 705/10

(57) ABSTRACT

At the information delivery server, access logs for accesses to information items made by users are managed, and a correlation detection condition indicating at least one information item is received from a client. Then, related users who made accesses to that at least one information item are detected according to the access logs, correlated information items that are accessed by the related users are extracted according to the access logs, and the correlated information items are delivered to the client.

### BACKGROUND OF THE INVENTION

1. Field of the Invention

The present invention relates to a scheme for information delivery through a network or media such as the Internet, a digital interactive TV network, or other information technology based home electronics network, and a scheme for advertisement on interactive media such as the Internet.

2. Description of the Related Art

In recent years, the use of the Internet or the like has been spreading drastically, but a user can only view accessed information such as Web pages, or acquire a list of retrieval result or the like. For example, when the book information retrieval is carried out at a bookstore site, the user can only acquire a list of books that matched the retrieval condition or the like, and the user cannot easily acquire information on other books that are related (correlated) to the retrieved books or the other information (of potential interest to the user).

Also, the conventional marketing information analysis presupposes the preliminary processing such as the input of the rating for each item from a user and the genre classification of items, and it has been necessary to set up complicated condition for the purpose of the correlation detection.

On the other hand, the interactive media such as the Internet in which reactions to the advertisement can be returned immediately have been attracting attentions because it is possible to attract users more easily. In the advertisement using such media, what is important is not just how many users have viewed the advertisement but also how many users have issued requests for acquiring additional information.

The known methods for posting advertisement on the interactive media include the following.

(1) A method for posting advertisement at random.

(2) A method for posting advertisement in relation to some contents.

(3) A method for posting advertisement according to the static attribute information users.

(4) A method for posting advertisement in response to explicit inputs of the current interests made by users.

Among them, the methods (1) and (2) are generally known methods that are also used in the conventional mass media. The advertisement on newspaper or the like is set in wide circulation so that it corresponds to the method (1). The advertisement on TV or the like is provided in relation to a specific TV program so that it corresponds to the method (2). Even in the WWW service on the Internet, the method for posting advertisement only in relation to the specific content has been used.

In the methods (1) and (2), what kind of users will be actually viewing the advertisement is indefinite, so that the methods (3) and (4) are mainly used in the Interactive media in order to increase the number of requests for acquiring additional information. However, the methods (3) and (4) are associated with the following programs.

(i) There is a need for the user to enter information such as the user attribute at every occasion, which can be quite tedious for the user.

(ii) The information entered by the user at some timing will be used subsequently so that the information on the user becomes fixed or obsolete.

(iii) There is no guarantee that the user enters correct information.

Also, the known systems for delivering the advertisement through the Internet or a network include the following.

There is a system in which the advertisement for items in the same or similar genre as the items purchased by a customer in the past will be delivered to that customer.

There is also a system in which the advertisement is delivered to those customers who accessed information related to items in the same genre as the advertisement target item (the banner advertisement delivery technique of the Double Click corporation).

There is also a system in which the analysis such as the correlation analysis is applied to the past purchase logs in order to extract distributions of attributes such as interests, age blocks, sex, jobs, etc. of those customers who purchased the advertisement target item, and the advertisement is delivered to those customers who have attribute values that are majority in the attribute distributions.

However, the conventional advertisement delivery systems are associated with the following problems.

(a) There is a need for a pre-registration of customer's attribute information such as interests, age, job, etc., and this pre-registration of attributes can hinder the increase of the customers.

(b) Even when there is a change in the attribute of the customer, this change in the attribute will not be accounted as long as the registered attributes are not updated.

(c) There is a need for a registration of attribute information such as genre (category), etc., for items, which requires tedious management. In this regard, if only the rough genre classification is used, the tediousness of the management will be alleviated but the accuracy in narrowing down the advertisement delivery targets will be degraded. For example, if all of Hollywood movies, French movies and Japanese movies are classified into a rough genre of “movies” and the advertisement of the French movie is delivered to those who are interested in “movies”, this advertisement is not effective to those who prefer the Hollywood movies.

(d) The advertisement delivery targets are bounded by category or genre, so that it is impossible to delivery the advertisement to those customers who are potentially likely to have interests (potential customers) in view of the correlations that are not bounded by category or genre.

### BRIEF SUMMARY OF THE INVENTION

It is therefore an object of the present invention to provide a scheme for information delivery through a network such as the Internet or digital interactive TV network, in which information related to some information can be easily provided to a client without requiring information rating input or complicated condition setting for the purpose of the correlation detection.

It is another object of the present invention to provide a scheme for providing advertisement on interactive media in which there is no need for the user to enter information at every occasion, potentially interested users can be extracted automatically, and the advertisement most appropriate to each user can be provided.

It is another object of the present invention to provide a scheme for providing advertisement in which the advertisement can be delivered only to the potential customers who are likely to purchase the advertised item, without requiring the registration of the customer attributes and the item attributes.

According to one aspect of the present invention there is provided a method for information delivery, comprising the steps of: managing access logs for accesses to information items made by users; receiving a correlation detection condition indicating at least one information item from a client; detecting related users who made accesses to said at least one information item according to the access logs; extracting correlated information items that are accessed by the related users according to the access logs; and delivering the correlated information items to the client.

According to another aspect of the present invention there is provided an information delivery device, comprising: a unit configured to manage access logs for accesses to information items made by users; a unit configured to receive a correlation detection condition indicating at least one information item from a client; a unit configured to detect related users who made accesses to said at least one information item according to the access logs; a unit configured to extract correlated information items that are accessed by the related users according to the access logs; and a unit configured to deliver the correlated information items to the client.

According to another aspect of the present invention there is provided a computer usable medium having computer readable program codes embodied therein for causing a computer to function as an information delivery server, the computer readable program codes include: a first computer readable program code for causing said computer to manage access logs for accesses to information items made by users; a second computer readable program code for causing said computer to receive a correlation detection condition indicating at least one information item from a client; a third computer readable program code for causing said computer to detect related users who made accesses to said at least one information item according to the access logs; a fourth computer readable program code for causing said computer to extract correlated information items that are accessed by the related users according to the access logs; and a fifth computer readable program code for causing said computer to deliver the correlated information items to the client.

According to another aspect of the present invention there is provided a method for providing advertisement, comprising the steps of: managing access logs for accesses made by users with respect to information provided by an information provider, and advertisement information to be provided to a client who is a user accessing target information specified in advance, the advertisement information being associated with additional information that can be accessed by the client from the advertisement information; adding access logs of advertisement agents who are virtual users accessing both the target information and the additional information, to the access logs; and providing the advertisement in response to a request from the client, by detecting the advertisement agents as related users who made accesses to the target information besides the client according to the access logs, extracting the additional information as correlated information that is accessed by the related users according to the access logs, and delivering the advertisement information managed in association with the additional information as extracted, to the client.

According to another aspect of the present invention there is provided an advertisement providing device, comprising: a unit configured to manage access logs for accesses made by users with respect to information provided by an information provider, and advertisement information to be provided to a client who is a user accessing target information specified in advance, the advertisement information being associated with additional information that can be accessed by the client from the advertisement information; a unit configured to add access logs of advertisement agents who are virtual users accessing both the target information and the additional information, to the access logs; and a unit configured to provide the advertisement in response to a request from the client, by detecting the advertisement agents as related users who made accesses to the target information besides the client according to the access logs, extracting the additional information as correlated information that is accessed by the related users according to the access logs, and delivering the advertisement information managed in association with the additional information as extracted, to the client.

According to another aspect of the present invention there is provided a computer usable medium having computer readable program codes embodied therein for causing a computer to function as an advertisement providing server, the computer readable program codes include: a first computer readable program code for causing said computer to manage access logs for accesses made by users with respect to information provided by an information provider, and advertisement information to be provided to a client who is a user accessing target information specified in advance, the advertisement information being associated with additional information that can be accessed by the client from the advertisement information; a second computer readable program code for causing said computer to add access logs of advertisement agents who are virtual users accessing both the target information and the additional information, to the access logs; and a third computer readable program code for causing said computer to provide the advertisement in response to a request from the client, by detecting the advertisement agents as related users who made accesses to the target information besides the client according to the access logs, extracting the additional information as correlated information that is accessed by the related users according to the access logs, and delivering the advertisement information managed in association with the additional information as extracted, to the client.

According to another aspect of the present invention there is provided a method for providing advertisement, comprising the steps of: managing access logs for accesses to information items made by users; detecting primary users who made accesses to an advertisement target information item or information items related to the advertisement target information item according to the access logs; extracting related information items that are accessed by the primary users according to the access logs; determining potential users who made accesses to the related information items according to the access logs; and delivering the advertisement target information item to the potential users.

According to another aspect of the present invention there is provided an advertisement providing device, comprising: a unit configured to manage access logs for accesses to information items made by users; a unit configured to detect primary users who made accesses to an advertisement target information item or information items related to the advertisement target information item according to the access logs; a unit configured to extract related information items that are accessed by the primary users according to the access logs; a unit configured to determine potential users who made accesses to the related information items according to the access logs; and a unit configured to deliver the advertisement target information item to the potential users.

According to another aspect of the present invention there is provided a computer usable medium having computer readable program codes embodied therein for causing a computer to function as an advertisement providing server, the computer readable program codes include: a first computer readable program code for causing said computer to manage access logs for accesses to information items made by users; a second readable program code for causing said computer to detect primary users who made accesses to an advertisement target information item or information items related to the advertisement target information item according to the access logs; a third computer readable program code for causing said computer to extract related information items that are accessed by the primary users according to the access logs; a fourth computer readable program code for causing said computer to determine potential users who made accesses to the related information items according to the access logs; and a fifth computer readable program code for causing said computer to deliver the advertisement target information item to the potential users.

Other features and advantages of the present invention will become apparent from the following description taken in conjunction with the accompanying drawings.

### BRIEF DESCRIPTION OF THE DRAWINGS

FIG. 1 is a block diagram showing a configuration of an information delivery system according to the first embodiment of the present invention.

FIG. 2 is a flow chart for an access log acquisition processing in the information delivery system of FIG. 1.

FIG. 3 is a flow chart for a client registration processing in the information delivery system of FIG. 1.

FIG. 4 is a flow chart for a correlated item delivery registration processing in the information delivery system of FIG. 1.

FIG. 5 is a flow chart for a correlated item detection processing (overall) in the information delivery system of FIG. 1.

FIG. 6 is a diagram showing a correlated item detection processing in the information delivery system of FIG. 1 conceptually.

FIG. 7 is a flow chart for a correlated item detection processing (detail) in the information delivery system of FIG. 1.

FIG. 8 is a flow chart for a correlated item delivery and charging processing in the information delivery system of FIG. 1.

FIG. 9 is a flow chart for a charge information totalization processing in the information delivery system of FIG. 1.

FIG. 10 is a diagram showing a correlated item delivery in the information delivery system of FIG. 1 conceptually.

FIG. 11 is a block diagram showing a configuration of an advertisement providing system according to the second embodiment of the present invention.

FIG. 12 is a diagram showing an overall advertisement presentation processing in the advertisement providing system of FIG. 11.

FIG. 13 is a diagram showing a social filtering information presentation processing in the advertisement providing system of FIG. 11 conceptually.

FIG. 14 is a diagram showing a potential target information extraction processing in the advertisement providing system of FIG. 11 conceptually.

FIG. 15 is a flow chart for a potential target information extraction processing in the advertisement providing system of FIG. 11.

FIG. 16 is a diagram showing an advertisement presentation processing in the advertisement providing system of FIG. 11 conceptually.

FIG. 17 is a flow chart for an advertisement presentation processing in the advertisement providing system of FIG. 11.

FIG. 18 is a diagram showing an exemplary form of an advertisement presentation in the advertisement providing system of FIG. 11.

FIG. 19 is a diagram showing four exemplary payment methods that can be used in the advertisement providing system of FIG. 11.

FIG. 20 is a diagram showing an example of a user's access log used in the advertisement providing system of FIG. 11.

FIG. 21 is a diagram showing an example of an advertisement information used in the advertisement providing system of FIG. 11.

FIG. 22 is a diagram showing an example of a target information used in the advertisement providing system of FIG. 11.

FIG. 23 is a diagram showing an example of a potential target information used in the advertisement providing system of FIG. 11.

FIG. 24 is a diagram showing an example of an advertisement agent's access log used in the advertisement providing system of FIG. 11.

FIG. 25 is a diagram showing an example of an attribute setting used in the advertisement providing system of FIG. 11.

FIG. 26 is a diagram showing an advertisement information used in a concrete example of the advertisement providing system of FIG. 11.

FIG. 27 is a diagram showing a target information used in a concrete example of the advertisement providing system of FIG. 11.

FIG. 28 is a diagram showing a potential target information used in a concrete example of the advertisement providing system of FIG. 11.

FIG. 29 is a diagram showing an advertisement agent's access log used in a concrete example of the advertisement providing system of FIG. 11.

FIG. 30 is a diagram showing an attribute setting used in a concrete example of the advertisement providing system of FIG. 11.

FIG. 31 is a diagram showing conditions of a contract for one exemplary payment method used in a concrete example of the advertisement providing system of FIG. 11.

FIG. 32 is a diagram showing a report after an advertisement posting period for one exemplary payment method used in a concrete example of the advertisement providing system of FIG. 11.

FIG. 33 is a diagram showing a report after an advertisement posting period extension for another exemplary payment method used in a concrete example of the advertisement providing system of FIG. 11.

FIG. 34 is a diagram showing a report after an advertisement posting period for still another exemplary payment method used in a concrete example of the advertisement providing system of FIG. 11.

FIG. 35 is a diagram showing conditions of a contract for yet another exemplary payment method used in a concrete example of the advertisement providing system of FIG. 11.

FIG. 36 is a diagram showing a report after an advertisement posting period for yet another exemplary payment method used in a concrete example of the advertisement providing system of FIG. 11.

FIG. 37 is a block diagram showing one part of a configuration of an advertisement delivery system according to the third embodiment of the present invention.

FIG. 38 is a block diagram showing another part of a configuration of an advertisement delivery system according to the third embodiment of the present invention.

FIG. 39 is a diagram showing an example of an access log list used in the advertisement delivery system of FIGS. 37 and 38.

FIG. 40 is a diagram showing a potential customer extraction processing in the advertisement delivery system of FIGS. 37 and 38 conceptually.

FIG. 41 is a diagram showing an example of an advertisement target item list used in the advertisement delivery system of FIGS. 37 and 38.

FIG. 42 is a diagram showing an example of a potential customer list used in the advertisement delivery system of FIGS. 37 and 38.

FIG. 43 is a flow chart for a customer ID assigning operation in the advertisement delivery system of FIGS. 37 and 38.

FIG. 44 is a flow chart for an access log generation operation in the advertisement delivery system of FIGS. 37 and 38.

FIG. 45 is a flow chart for an access log collection operation in the advertisement delivery system of FIGS. 37 and 38.

FIG. 46 is a flow chart for a potential customer extraction operation in the advertisement delivery system of FIGS. 37 and 38.

FIG. 47 is a flow chart for an advertisement delivery operation in the advertisement delivery system of FIGS. 37 and 38.

### DETAILED DESCRIPTION OF THE INVENTION

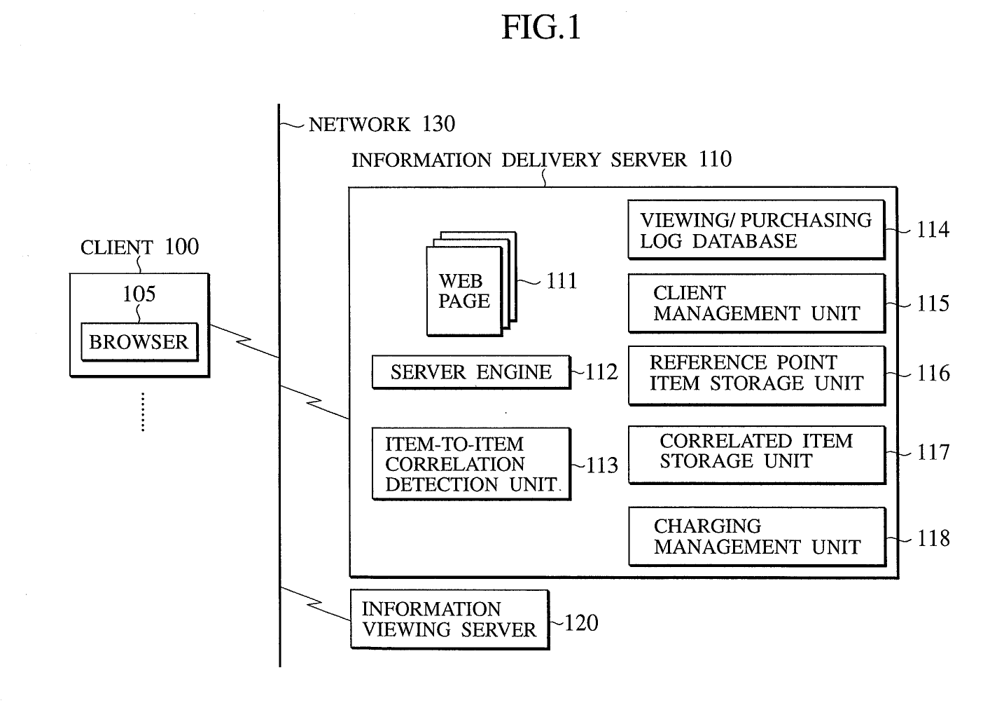

Referring now to FIG. 1 to FIG. 10, the first embodiment of the present invention which is directed to the information delivery scheme will be described in detail.

Here, the term item will be used for any information such as data, product, advertisement, Web page title, etc. that can be viewed, put into a shopping cart, or purchased by a client through a browser on the Internet. The item can be uniquely identified by an item identifier (ID) such as URL of the Web, product code, etc.

FIG. 1 shows an exemplary system configuration in this embodiment, which comprises a client 100, an information delivery server (item delivery server) 110, an information viewing server (item viewing server) 120, and a network 130 for interconnecting them such as the Internet. In general, there are many clients 100 on the network 130.

The client 100 can be a device accessible to the Web such as PC, digital TV set, portable telephone, etc., which has a browser 105. The browser 105 is an information access mechanism such as Web browser which is capable of searching items, purchasing items, receiving recommendation on items, etc. Note however that the browser 105 is not necessarily limited to the Web browser and can be anything that are capable of functioning as an input unit for enabling the client 100 to execute a subscription processing for a correlated item delivery with respect to the information delivery server 110 and as an output unit for displaying a correlated item list.

The information viewing server (item viewing server) 120 is an EC server or the like, from which products or information can be viewed and purchased through a search server or a network, which maintains the item viewing/purchasing log regarding the item viewing or the item purchasing made in the past. The item viewing/purchasing log is maintained in a format containing information on “user identifier, item ID, viewing date and time”, for example, which can be realized by utilizing the access log of the Web server or as an independent log maintaining function. The user identifier is an identifier for uniquely identifying the user using the information viewing server 120 globally, which is usually allocated to a terminal of the user by the information viewing server 120.

Note that there can be a plurality of information viewing servers 120 on the network 130 (and this is usually the case in general), but in such a case, it is necessary for an item representing the same information or the same product to have the identical item ID on the plurality of information viewing servers 120, and it is also necessary for the user identifier to be capable of identifying the identical user on the plurality of information viewing servers 120.

To this end, the item viewing/purchasing logs of the plurality of information viewing servers 120 should be collected at a log management server through the network or the like so as to realize the centralized management of all the item viewing/purchasing logs, although this feature is omitted in FIG. 1. The user identifiers should also be managed by the centralized management. Alternatively, a globally unique user identifier that is valid over the plurality of information viewing servers 120 can be allocated by each information viewing server by inquiring to the log management server at a time of allocating the user identifier.

The information delivery server (item delivery server) 110 acquires the item viewing/purchasing log from the information viewing server 120 periodically, maintains it therein, and carries out the correlated item delivery to the client 100 who registered the correlated item delivery in advance by utilizing the maintained item viewing/purchasing log.

The information delivery server 110 comprises Web pages 111, a server engine 112, an item-to-item correlation detection unit 113, a viewing/purchasing log database 114, a client management unit 115, a reference point item storage unit 116, a correlated item storage unit 117, and a charging management unit 118.

The server engine 112 receives an HTTP request for accessing the Web page 111 identified by the URL and provides the Web page 111 to the client 100. Here, it is assumed that the HTTP request can indicate the fact that the client 100 has carried out a registration for requesting the correlated item delivery, and that the correlated item list can be displayed at the client 100.

The item-to-item correlation detection unit 113 carries out the correlation item detection processing periodically. As the correlation item detection method, it is possible to use the statistical method using class discrimination or the like, or the data mining method using neural network, genetic algorithm, demographic clustering, etc., but in this embodiment, the method for detecting the correlation (similarity) between information and information using the social filtering (SF) will be utilized, The social filtering will be described in detail later on.

The viewing/purchasing log database 114 maintains the item viewing/purchasing log that is acquired periodically from the information viewing server 120, The item viewing/purchasing log is maintained in a format containing information of “user identifier, item ID, viewing date and time”.

The client management unit 115 manages the correlated item delivery targets. When the client 100 carries out the registration for the correlated item delivery for the first time, a client identifier for uniquely identifying the client 100 globally is allocated, and this client identifier is managed along with a keyword received from the client 100 at the same time. Then, the client identification is carried out when the client 100 makes an access to the information delivery server 110.

The reference point item storage unit 116 maintains a list of items to be used as reference points with respect to which the correlation should be detected, along with the client identifier.

The correlated item storage unit 117 maintains the latest correlated item list obtained by the detection processing by the item-to-item correlation detection unit 113, along with the client identifier.

The charging management unit 118 manages an amount to be charged for the correlated item delivery. Here, a flat rate charge or a meter rate charge according to a delivered information amount is managed along with the client identifier.

The operation of this system can be largely divided into the access log acquisition, the correlated item delivery target client registration, the correlated item delivery registration, the correlated item detection, the correlated item delivery and charging, and the charge information totalization, which will now be described in this order.

[Access Log Acquisition]

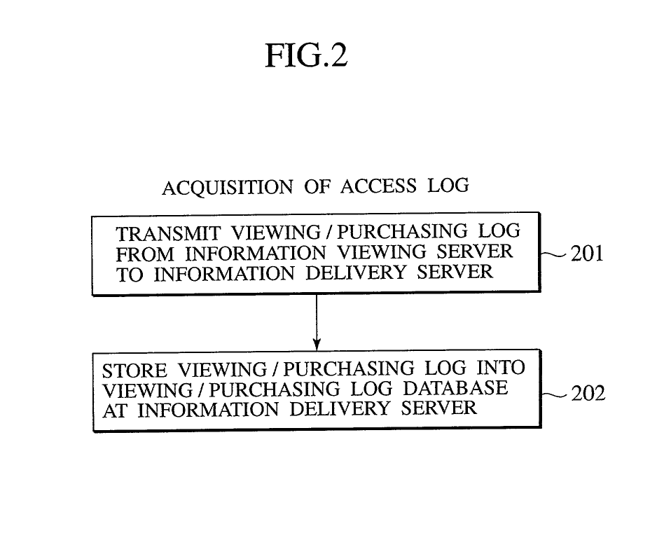

FIG. 2 shows the processing flow for the access log acquisition. The information viewing server 120 sends the viewing/purchasing log to the information delivery server 110 periodically (step 201). Then the information delivery server 110 stores the viewing/purchasing log received from the information viewing server 120 into the viewing/purchasing log database 114 (step 202). the viewing/purchasing log in the viewing/purchasing log database 114 can be deleted after a prescribed period of time has elapsed, for example.

[Client Registration]

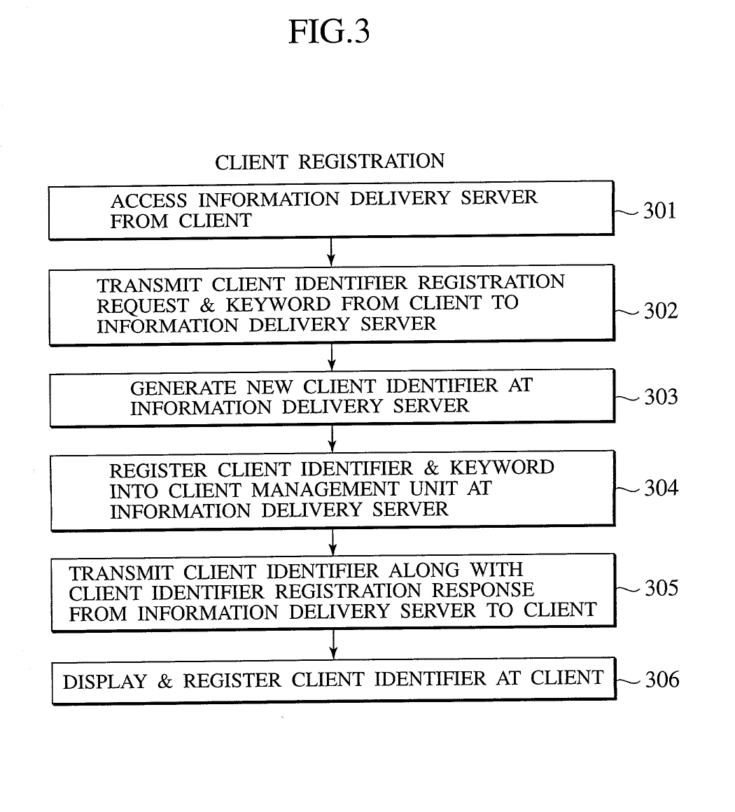

FIG. 3 shows the processing flow for the client registration. This is a processing for assigning the client identifier (user identifier) to the correlated item delivery target client, which must be carried out prior to the correlated item delivery registration.

The client 100 accesses to the information delivery server 110 through the network 130 such as the Internet by using the browser 105 (step 301), and transmits the client identifier registration request along with the keyword to the information delivery server 110 (step 302). The information delivery server 110 generates a globally unique user identifier as the client identifier (step 303), and registers this generated client identifier (user identifier) and the keyword received from the client 100 into the client management unit 115 (step 304). The client identifier and the keyword registered in the client management unit 115 will be utilized in identifying the client 100 when an access from the client 100 is made subsequently.

Next, the information delivery server 110 transmits a client identifier registration response along with the client identifier (user identifier) to the client 100 (step 305). Upon receiving the client identifier registration response and the client identifier, the client 100 displays this client identifier (user identifier) (step 306). Thereafter, the client 100 can carry out the reference point item registration and receive the correlated item delivery by sending the client identifier received from the information delivery server 110 and the above keyword to the information delivery server 110. Note that the client identifier can be maintained at the client side by utilizing the function of Cookie or the like.

[Correlated Item Delivery Registration]

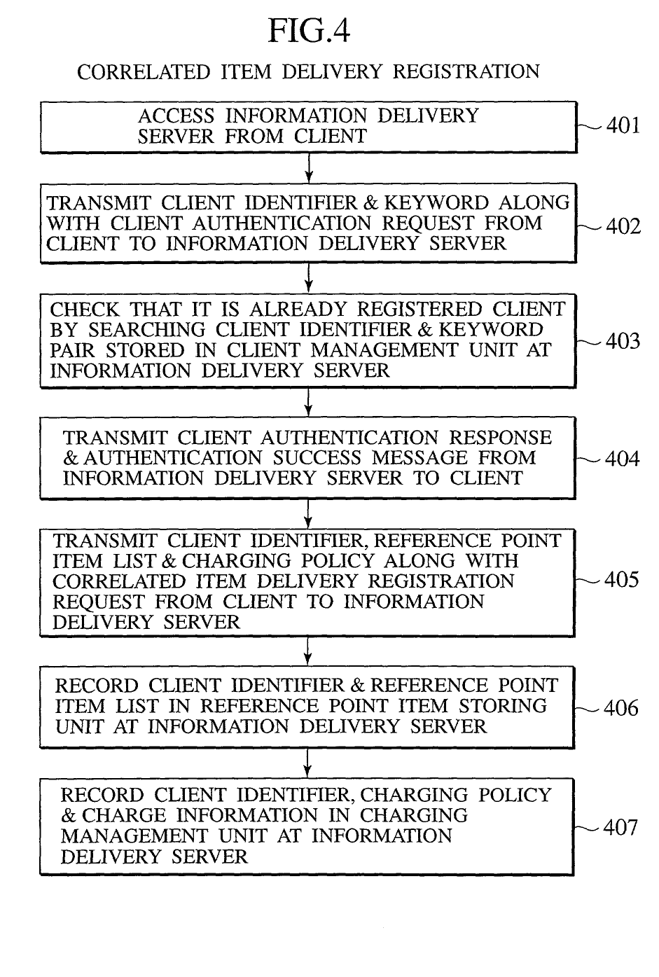

FIG. 4 shows the processing flow for the correlated item delivery registration. This is a processing for registering a reference point item list, a charging policy, etc., from the client. The reference point item list defines the correlation detection condition, i.e., a list of items to be used as reference points with respect to which the correlation should be detected. By registering the reference point items in the information delivery server 110 in advance, it becomes possible for the client 100 to receive the delivery of a group of items that are correlated to the group of reference point items described in the reference point item list from the information delivery server 110.

The client 100 accesses to the information delivery server 110 through the network 130 such as the Internet by using the browser 105 (step 401). At a time of accessing the information delivery server 110, the server engine 112 of the information delivery server 110 receives the HTTP request for accessing a Web page (a correlated item delivery registration page) identified by the URL, and provides this Web page to the client 100.

The client 100 transmits the client identifier (user identifier) assigned earlier and the keyword along with a client authentication request to the information delivery server 110 (step 402). Upon receiving the client identifier and the key word along with the client authentication request, the information delivery server 110 checks that it is the already registered client by searching a client identifier and keyword pair stored in the client management unit 115 (step 403), and returns a client authentication response and an authentication success message to the client 100 (step 404). If it is not the already registered client, the information delivery server 110 returns the client authentication response and an authentication failure message to the client 100 and terminates the processing.

Upon receiving the client authentication response and the authentication success message, the client 100 transmits the client identifier, the reference point item list, the charging policy along with a correlated item delivery registration request to the information delivery server 110 (step 405). The reference point item list is a list of items to be used as reference points with respect to which the correlation should be detected, and the charging policy indicates either a flat rate or a meter rate. Note that, in order to avoid the security violation, the client 100 may always transmit the keyword along with the correlated item delivery registration request and the information delivery server 110 may always carry out the client identifier authentication.

The information delivery server 110 records the client identifier and the reference point item list received from the client 100 in the reference point item storage unit 116 (step 406). Then, the information delivery server 110 records the client identifier, the charging policy and a charge information in the charging management unit 118 (step 407). Here, the charge information indicates an amount to be charged for a prescribed period of time (one month, for example) in the case where the charging policy is the flat rate, or an amount to be changed according to a delivered information amount in the case where the charging policy is the meter rate.

[Correlated Item Detection]

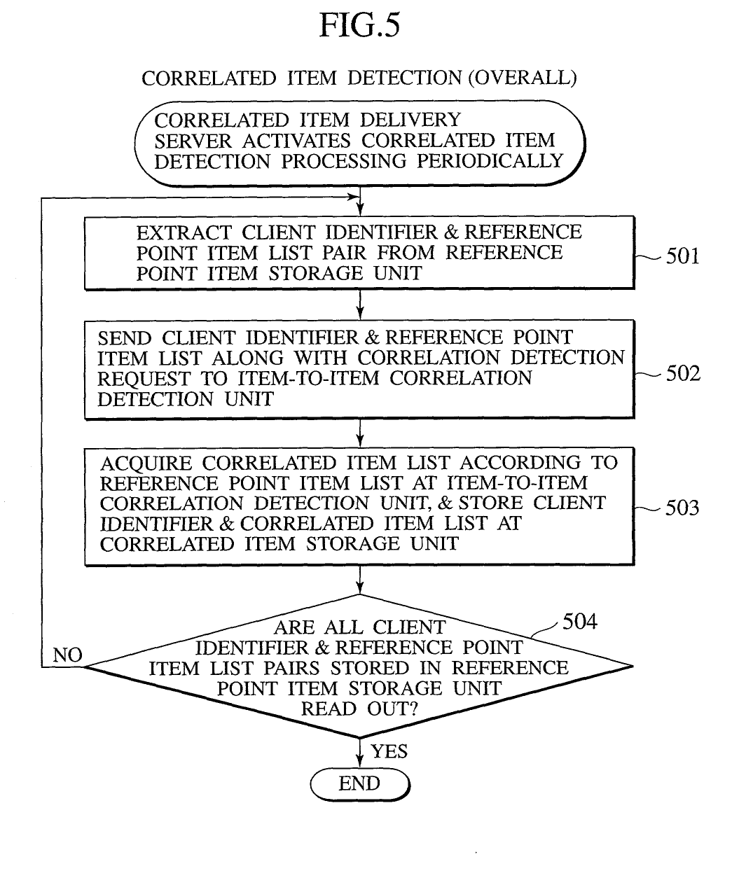

The information delivery server 110 carries out the correlated item detection processing periodically (daily, for example). FIG. 5 shows an overall processing flow for the correlated item detection.

First, a pair of the client identifier and the reference point item list stored in the reference point item storage unit 117 is extracted (step 501), and the client identifier and the reference point item list are given to the item-to-item correlation detection unit 113 along with a correlation detection request (step 502). The item-to-item correlation detection unit 113 extracts a list of correlated items according to the reference point item list from the viewing/purchasing log database 114, and stores the client identifier and the correlated item list in the correlated item storage unit 117 (step 503). Thereafter, the steps 501 to 503 are repeated until all data stored in the reference point item storage unit 116 are read out (step 504).

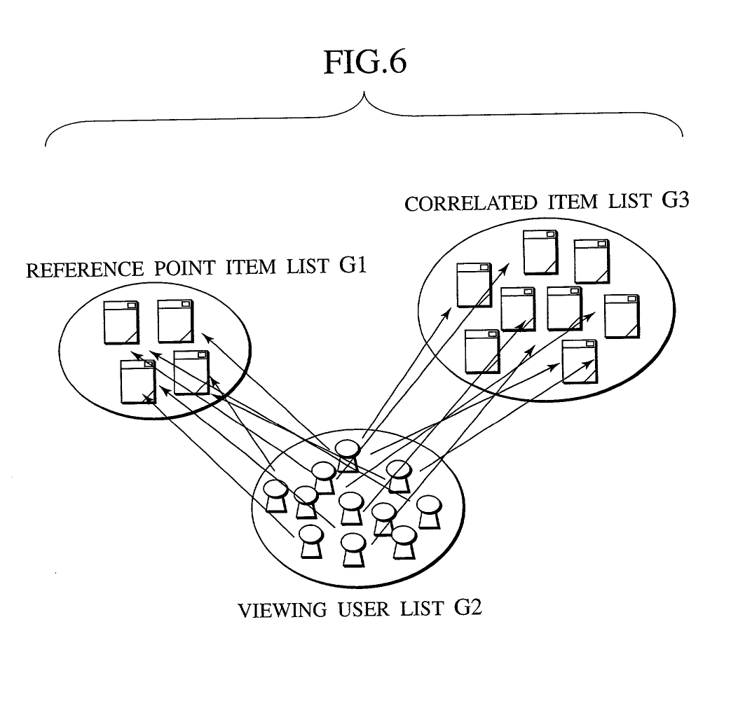

FIG. 6 shows a basic principle of the correlated item detection in this embodiment conceptually. Here, the reference point item list (a list of items to be used as reference points with respect to which the correlation should be detected) will be denoted as G1, and a list of users who are not the user that provided the reference point item list and who have viewed G1 will be denoted as G2, and this G2 will be referred to as a viewing user list. Then, a list of items viewed by this viewing user list G2 excluding those items contained in G1 is defined as a correlated item list G3. Namely, it is conjectured that G3 should be interesting to the user of G1 as well. In practice, G2 and G3 are obtained by multiplying elements by weights (indicating viewing operation counts) and selecting a prescribed number of elements.

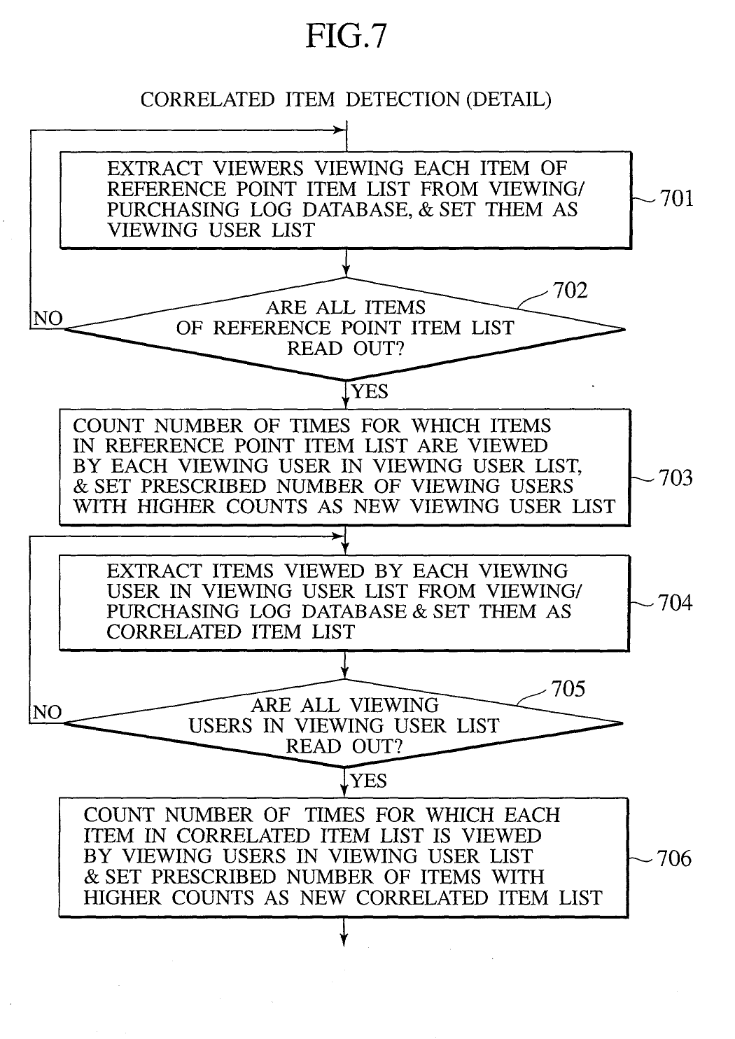

FIG. 7 shows the processing flow for the item-to-item correlation detection unit 113. In the item-to-item correlation detection unit 113, first, viewers (users) who are viewing each item of the reference point item list (G1) are extracted from the viewing/purchasing log database 114, and stored as the viewing user list (G2) (step 701). This operation is repeated for all the items in the reference point item list (step 702). Then, the number of times for which items in the reference point item list are viewed by each user in the viewing user list is counted, the viewing users in the viewing user list are rearranged into the descending order of the counts, and only a prescribed number of viewing users with the higher counts are selected and stored as the new viewing user list (step 703).

Next, the items viewed by each viewing user in the viewing user list obtained at the step 703 are extracted from the viewing/purchasing log database 114, and stored as the correlated item list (G3) (step 704). This operation is repeated for all the viewing users in the viewing user list (step 705). Then, those items contained in G1 are excluded, the number of times for which each item in the correlated item list is viewed by the viewing users in the viewing user list is counted, the items in the correlated item list are rearranged into the descending order of their counts, and only a prescribed number of correlated items with higher counts are selected and stored as the new correlated item list (step 706).

This correlated item list is stored in the correlated item storage unit 117 along with the client identifier corresponding to the reference point item list (step 503 of FIG. 5). In this way, the correlated item storage unit 117 maintains the latest correlated item list corresponding to the reference point item list for each client. When the client changes the reference point item list, the correlated item list in the correlated item storage unit 117 is also changed in accordance with the changed reference point item list.

[Correlated Item Delivery and Charging]

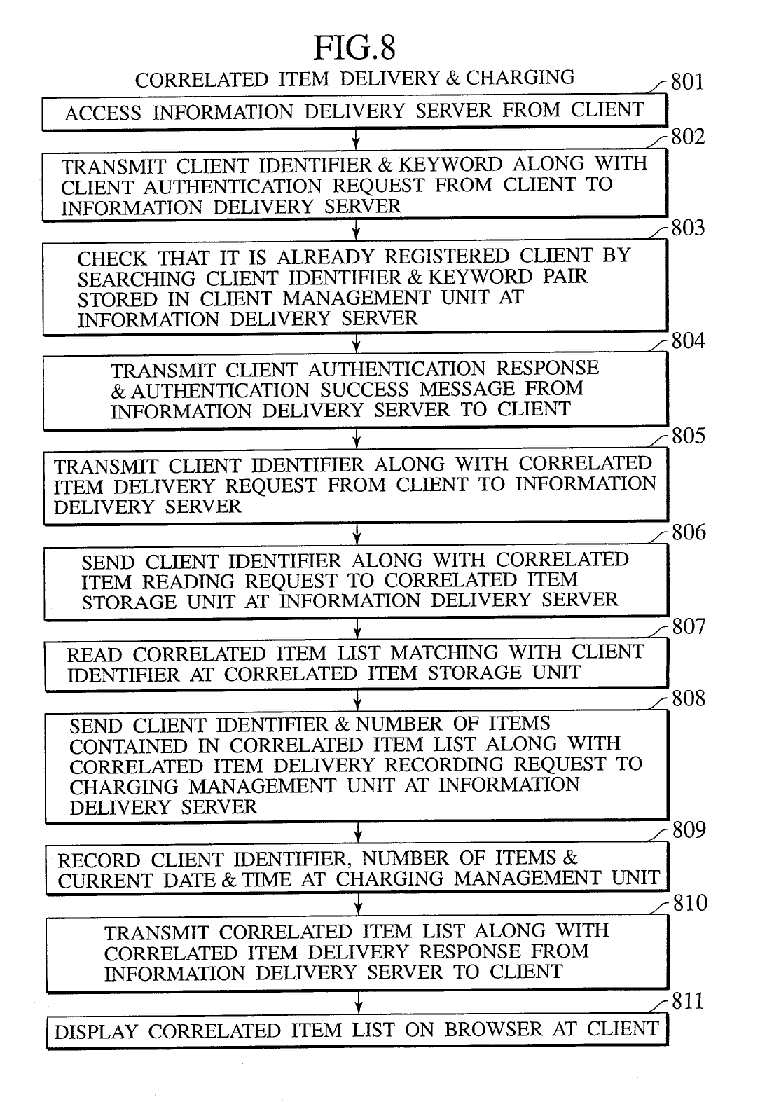

FIG. 8 shows the processing flow for the correlated item delivery and charging.

The client 100 accesses to the information delivery server 110 through the network 130 such as the Internet by using the browser 105 (step 801). At a time of accessing the information delivery server 110, the server engine 112 of the information delivery server 110 receives the HTTP request for accessing a Web page (a correlated item delivery page) identified by the URL, and provides this Web page to the client 100.

The client 100 transmits the client identifier and the keyword along with a client authentication request to the information delivery server 110 (step 802). Upon receiving the client identifier and the key word along with the client authentication request, the information delivery server 110 checks that it is the already registered client by searching a client identifier and keyword pair stored in the client management unit 115 (step 803), and returns a client authentication response and an authentication success message to the client 100 (step 804). If it is not the already registered client, the information delivery server 110 returns the client authentication response and an authentication failure message to the client 100 and terminates the processing.

Upon receiving the client authentication response and the authentication success message, the client 100 transmits the client identifier along with a correlated item delivery request to the information delivery server 110 (step 805). Note that, in order to avoid the security violation, the client 100 may always transmit the keyword along with the correlated item delivery request and the information delivery server 110 may always carry out the client identifier authentication.

The information delivery server 110 sends the client identifier received from the client 100 along with a correlated item reading request to the correlated item storage unit 117 (step 806). The correlated item storage unit 117 reads out the correlated item list matching with the client identifier according to the client identifier received along with the correlated item reading request (step 807). Then, the information delivery server 110 sends the client identifier and the number of items contained in the correlated item list along with a correlated item delivery recording request to the charging management unit 118 (step 808), The charging management unit 118 records the client identifier, the number of items, and the current date and time (step 809).

After that, the information delivery server transmits the correlated item list along with the correlated item delivery response to the client 100 from which the correlated item delivery request was received (step 810). The client 100 then displays the correlated item list received from the information delivery server 110 on the browser 105 (step 811).

[Charge Information Totalization]

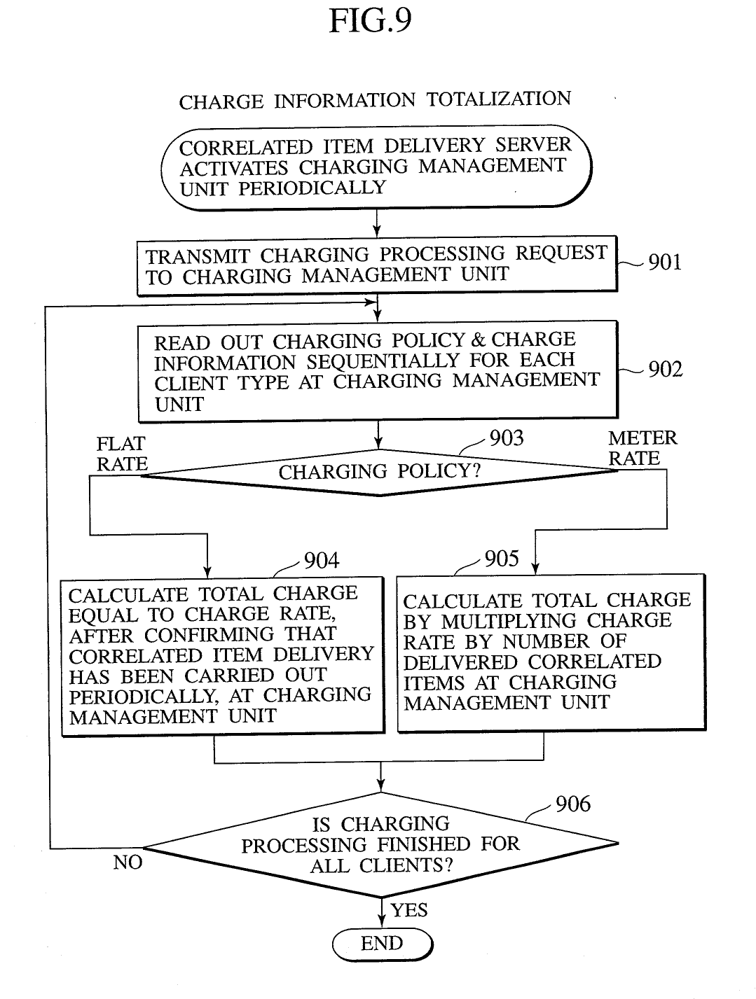

FIG. 9 shows the processing flow for the charge information totalization. The information delivery server 110 activates the charging management unit 118 periodically (monthly, for example) and carries out the charging processing according to the charge information.

The information delivery server 110 transmits a charging processing request to the charging management unit 118 periodically (monthly, for example) (step 901). The charging management unit 118 reads out the charging policy and the charge information sequentially for each client type (step 902). Then, in the case where the registered charging policy is the flat rate, the total change equal to the charge rate is calculated after confirming that the correlated item delivery has been carried out periodically (steps 903, 904). Also, in the case where the registered charging policy is the meter rate, the total charge is calculated by multiplying the charge rate by the number of delivered correlated items (steps 903, 905). Thereafter, the charging management unit 118 repeats the steps 902 to 905 until the charging processing is finished for all the registered clients (step 906).

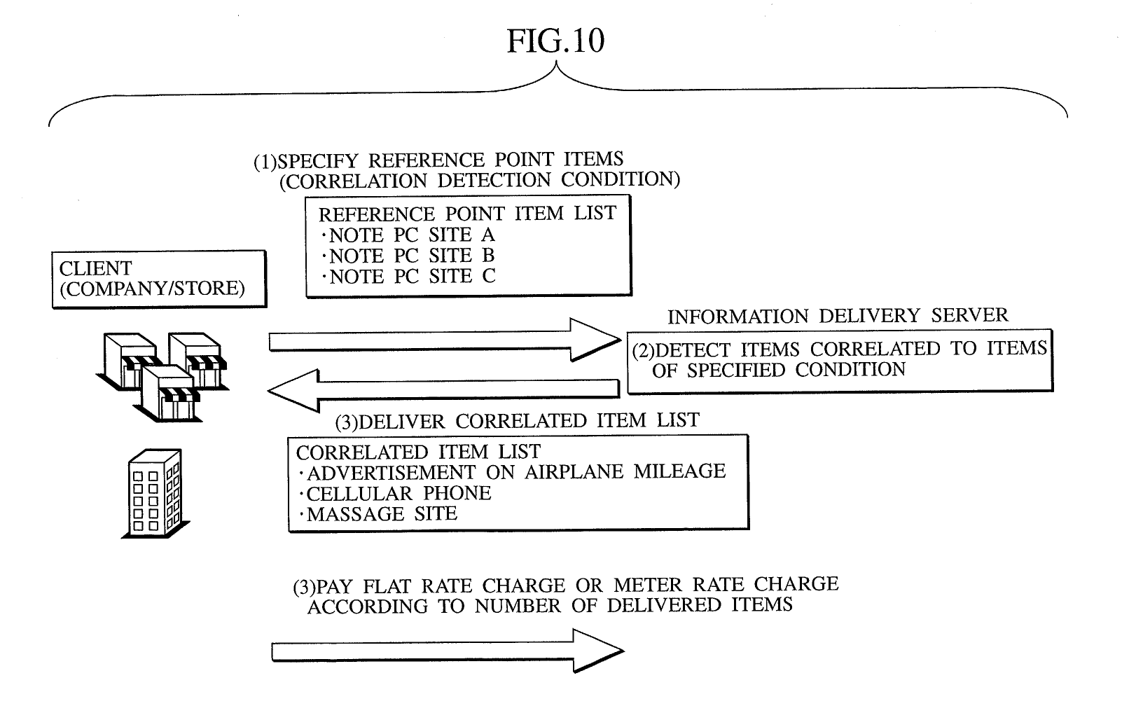

FIG. 10 shows a concrete example of the correlated item delivery according to this system. Here, the correlated items are detected according to the access log for the viewing of the information or the like made by the user in the past, which is maintained at the information delivery server. For example, the access log for the searching of books and the viewing of abstracts or the like at the bookstore site is stored as a log of the WWW server. The information to be stored can be “accessing user, information identifier, access date and time”, for example. In FIG. 10, the processing is carried out as follows.

(1) The client who is the information (item) delivery target carries out the registration of the correlation detection condition, i.e., the reference point items, in advance. The correlation detection condition indicates a list of information (items) to be used as reference points with respect to which the correlation should be detected.

(2) The information delivery server detects a list of correlated information (items) according to the information list obtained at (1), from the access log.

(3) The information delivery server delivers the correlated information (correlated item list), in response to the correlated item delivery request from the client or at a prescribed interval.

(4) The client pays the flat rate charge or the meter rate charge according to the delivered information amount (the delivered items number).

Note that it is possible to modify the above embodiment in various ways including the following.

(1) The network is not limited to the Internet, and can be a digital interactive TV network or an information technology based home electronnics network, for example.

(2) The client can be any of a PC, a cellular phone, a digital interactive TV set, an information technology based home electronics, a word processor with a communication function, a game instrument with a communication function, a watch with a communication function, and a mobile communication terminal such as PDA.

(3) The information input/output medium is not limited to the Web. It is possible to utilize the e-mail such that the correlated item delivery request and the client identifier or the like can be transmitted as the e-mail document or its title. It is also possible to utilize the e-mail address instead of the client identifier. It is also possible to transmit the correlated item list as the e-mail document.

(4) The correlated item list can be displayed in superposition to the TV display or the game display, for example.

(5) The timing for providing the correlated item list is not necessarily limited to when the correlated item delivery request is made by the client. The information delivery server can automatically access a memory device of the client and write the correlated item list periodically.

(6) There is no need to carry out the correlated item detection processing periodically (daily, for example). For example, the correlated item detection processing can be carried out when the correlated item delivery request is received from the client and the detected correlated items can be returned immediately. In this way, the correlated item storage unit can be omitted. Also, the reference point items can be sent when the user makes the correlated item delivery request. In this way, the reference point item storage unit cal also be omitted.

(7) There are many variations for the charging method. For example, it is possible to adopt a method in which the minimum number of the correlated items to be acquired is guaranteed and the fee is payed in advance at a time of the reference point item registration, and if the guaranteed minimum number is not reached after a prescribed service period, the correlated item delivery period is extended until the guaranteed minimum number is reached. It is also possible to adopt a method in which the minimum number of the correlated items to be acquired is guaranteed and the fee is payed in advance at a time of the reference point item registration, and if the guaranteed minimum number is not reached after a prescribed service period, a part or a whole of the fee is refunded according to the agreement. It is also possible to adopt a method in which the fee is payed after a prescribed service period ended according to the number of correlated items delivered in total.

(8) It is also possible to modify the processing of the item-to-item correlation detection unit 113 as shown in FIG. 7 as follows.

The first modification is directed to the case of realizing a method for extracting popular items from the entire group of items.

First, items in the reference point item list (G1) for which the total number of accesses is greater than or equal to a prescribed threshold are extracted, and the extracted reference point items are stored as a popular reference point item list (G1′).

Then, viewers (users) who are viewing each item of the popular reference point item list (G1′) are extracted from the viewing/purchasing log database 114. Here, the users who made accesses after prescribed date and time are extracted sequentially in the order of their access date and time such that only as many users as a prescribed number of users who made accesses earlier than the others are extracted or only those users who made accesses within a prescribed period of time are extracted. For example, the prescribed date and time can be set as the date and time of the oldest data, and m users who made the first m accesses after that date and time are extracted. In this way, the users so extracted can be regarded as users who paid attention to the popular items earlier, i.e., the users who are forerunners of the popularity trend.

These extracted users are stored as the viewing user list (G2), and this operation is repeated for all the items in the popular reference point item list.

Next, the items viewed by each viewing user in the viewing user list are extracted from the viewing/purchasing log database 114. Here, the items that are accessed since prescribed date and time until the present or during a prescribed period are extracted. For example, the items accesses in the past n days from now are extracted. The extracted items are stored as the correlated item list (G3), and this operation is repeated for all the viewing users in the viewing user list.

In this way, the correlated item list so obtained can be regarded as items to which the forerunners of the popularity trend are paying attention to, i.e., items that are expected to become popular next.

The second modification is directed to the case of realizing a method for extracting popular items from items having a specific attribute using users having a particular attribute.

First, items in the reference point item list (G1) for which the total number of accesses is greater than or equal to a prescribed threshold and which have a specific attribute are extracted, and the extracted reference point items are stored as a popular reference point item list (G1′). Here, the specific attribute can be a prescribed genre (cosmetics, dresses, etc., for example).

Then, viewers (users) who are viewing each item of the popular reference point item list (G1′) and who have a particular attribute are extracted from the viewing/purchasing log database 114. Here, the particular attribute can be a user type (women in their teens, twenties or thirties, for example) according to information obtained from the user profiles.

Here, again, the users who made accesses after prescribed date and time are extracted sequentially in the order of their access date and time such that only as many users as a prescribed number of users who made accesses earlier than the others are extracted or only those users who made accesses within a prescribed period of time are extracted. For example, the prescribed date and time can be set as the date and time of the oldest data, and m users who made the first m accesses after that date and time are extracted. The users so extracted can be regarded as users who paid attention to the popular items earlier, i.e., the users who are forerunners of the popularity trend in the specific genre among the particular type of users.

These extracted users are stored as the viewing user list (G2), and this operation is repeated for all the items in the popular reference point item list.

Next, the items viewed by each viewing user in the viewing user list which have the specific attribute are extracted from the viewing/purchasing log database 114. Here, the specific attribute is the prescribed genre (cosmetics, dresses, etc., for example) that is used in obtaining the popular reference point item list.

Here, again, the items that are accessed since prescribed date and time until the present or during a prescribed period are extracted. For example, the items accesses in the past n days from now are extracted. The extracted items are stored as the correlated item list (G3), and this operation is repeated for all the viewing users in the viewing user list.

In this way, the correlated item list so obtained can be regarded as items to which the forerunners of the popularity trend in the specific genre are paying attention to, i.e., items that are expected to become popular in the specific genre among the particular type of users next.

Note that, in the first and second modifications, the correlated items in the correlated item list can be ordered in various ways. For example, the number of times for which each item in the correlated item list is viewed by the viewing users in the viewing user list can be counted and the items in the correlated item list can be rearranged into the descending order of their counts, similarly as in the processing of FIG. 7. Alternatively, the number of viewing users in the viewing user list who viewed each item in the correlated item list can be counted and the items in the correlated item list can be rearranged into the descending order of their counts. It is also possible to rearrange the items in the correlated item list into the descending order of their access date and time.

As described, according to this first embodiment, the correlated items are detected solely on a basis of the access log. Consequently, there is no need to require time and effort for the information rating input and the registration of the genre classification with respect to the information in advance. Also, by using the access log that is sequentially updated, it is possible to detect the correlated information (correlated items) in accordance with the change of the interests of the user.

Also, according to this first embodiment, the correlated information is delivered by using only the information (items) to be used as reference points with respect to which the correlation should be detected, as the correlation detection condition. Consequently, there is no need to require the complicated condition setting for the purpose of the correlation detection and the correlation detection condition can be specified easily.

Note that the correlation detection condition can often be the corporate secret in general, and in this regard, this first embodiment only requires to specify the information list so that it suffices to send only this information list as the correlation detection condition (such that the possibility of the information leakage or the like can be eliminated).

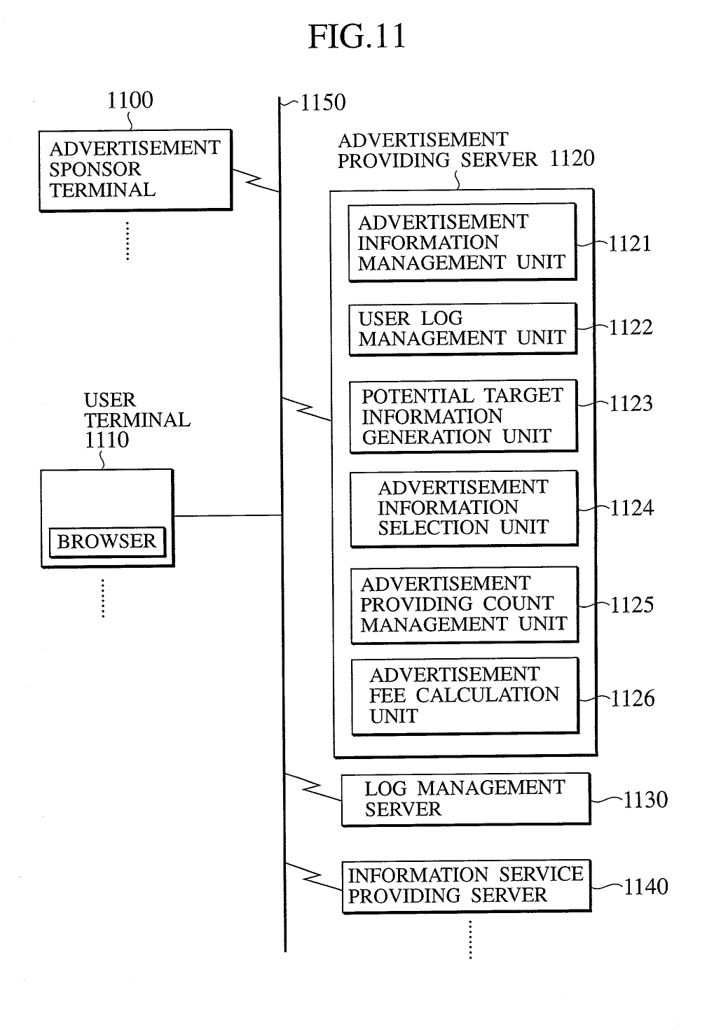

Next, with references to FIG. 11 to FIG. 36, the second embodiment of the present invention which is directed to the advertisement providing scheme will be described in detail.

In this embodiment, the user's access log for the interactive service such as that on the Internet in order to eliminate the user's time and effort to enter inputs. When the user views information of his/her interest, the information service provider keeps a record of that viewing. Also, when the user makes a specific action, a record of that action is kept. By collecting such records periodically, it is possible to obtain the access log (a collection of records) for the viewing of so-and-so information or the action on so-and-so date and time, with respect to each user. Then, using this access log, the advertisement is provided to the user. In this way, there is no need for the user to enter the input such as the user attribute at every occasion. Moreover, the information actually viewed by the user is utilized so that the latest and correct user information can be obtained.

In the following, the method for providing the advertisement to the user by using the access log will be described. Here, an algorithm generally known as the social filtering (SF) for calculating a similarity among a plurality of access logs will be used.

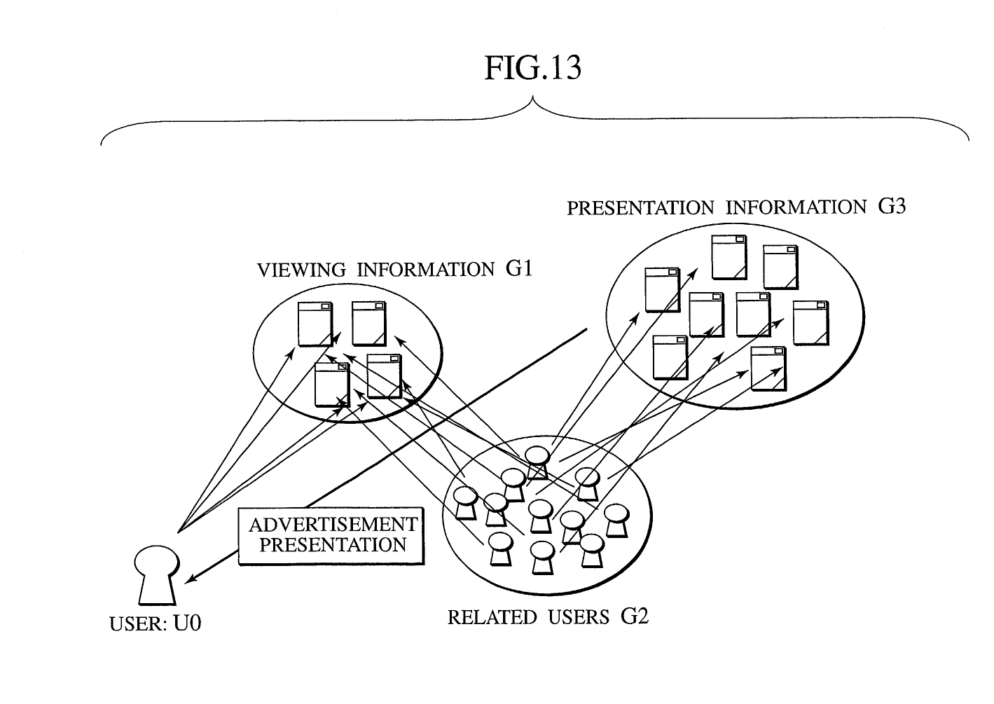

FIG. 13 shows a basic principle of the SF information presentation in this embodiment conceptually. When a group of informations viewed by the user U0 are denoted as G1, a group of users other than U0 who also viewed G1 will be referred to as a related user group G2. Then, a group of informations viewed by the related users of G2 other than G1 will be denoted as G3. This G3 is regarded as information which has a high similarity with respect to G1, that is, it is conjectured that G3 is information of interest for U0, and this G3 is provided to U0 as the presentation information.

Here, each related user of G2 has a value indicating the similarity level (such as the viewing count), and by using this information, a value indicating a conjectured interest level is assigned to each presentation information in G3. In this way, it is possible to realize a mechanism in which the presentation information is provided in the order of the conjectured interest level.

Also, attributes are set for the users and the information, such that the related users to be included in G2 can be selected according to the user attributes (filtering), and the presentation information to be included in G3 can be selected according to the information attributes.

FIG. 11 shows an exemplary system configuration in this embodiment, which comprises an advertisement sponsor terminal 1100, a user terminal 1110, an advertisement providing server 1120, and a log management server 1130, an information service providing server 1140, and a network 1150 for interconnecting them such as the Internet. In general, there are many clients 1100 and information service providing servers 1140 on the network 1150. There can also be many advertisement sponsor terminals 1100 and log management servers 1130 on the network 1150.

Here, the advertisement providing server 1120 comprises an advertisement information management unit 1121, a user log management unit 1122, a potential target information generation unit 1123, an advertisement information selection unit 1124, an advertisement providing count management unit 1125, an advertisement fee calculation unit 1126.

The advertisement information management unit 1121 manages advertisement information with respect to which the advertisement posting is requested by the advertisement sponsor. The user log management unit 1122 manages access log, i.e., viewing records, with respect to each information provided by the information service providing server 1140, This user log management unit 1122 also manages access logs of advertisement agents which are virtual users to be described below.

The potential target information generation unit 1123 generates a potential target information which has high similarity with respect to a target information that is related to the advertisement information. The advertisement information selection unit 1124 selects appropriate advertisement information according to the access log of the user and the access logs of the advertisement agents, and provides it to the user.

The advertisement providing count management unit 1125 manages the number of times for which the advertisement is viewed by the users (advertisement viewing count) and the number of time for which additional information is acquired by the users (additional information acquisition count). The advertisement fee calculation unit 1126 calculates an advertisement fee to be paid by the advertisement sponsor according to the advertisement viewing count, the additional information acquisition count, etc.

First, the collection of the user's access log will be described. When each user views each information of the information service providing server 1140 by using the user terminal 1110, the information service providing server 1140 obtains the access log of the user for such a viewing. The primary access log collection site is (a Web site of) the information service providing server 1140 that obtains this access log.

For this access log collection, the access log of each information page or product page at the Web site that is providing information or products can be used, for example. In general, a plurality of Web sites that have access logs can exist, and in such a case, it is necessary for an access representing the same information or the same product to be recorded under the identical name on the plurality of Web sites, and it is also necessary for the user identifier to be capable of identifying the identical user on the plurality of Web sites.

In this embodiment, it is assumed that the access log information of the information service providing server 1140 is collected through the network 1150 to the log management server 1130 which realizes the centralized management of all access logs. The user identifiers are also managed by the centralized management.

Depending on cases, the log management server 1130 and the information service providing server 1140 can be identical. For example, in the Web directory service that provides information on Web sites at one site, the access log indicating which site is selected by the user at a time of moving, and if the log management server is operated at the same site, the access log can be given to the log management server without sending it through the network. Also, if the access log can be acquired from a relay server between the information service providing sever and the user terminal, it is possible to utilize that access log.

On the other hand, many sites that are providing a large scale service have a plurality of service providing servers. In such a case, the access log at each server is send through the network to the log management server at a single location and managed there. The same also applies to the case where a network provider such as ISP (Internet Service Provider) has the service log.

The user identifier is usually allocated at the information service providing server 1140, and a globally unique user identifier that is valid over the plurality of sites can be allocated by matching user identifiers among the sites or by inquiring to the log management server at a time of allocating the user identifier.

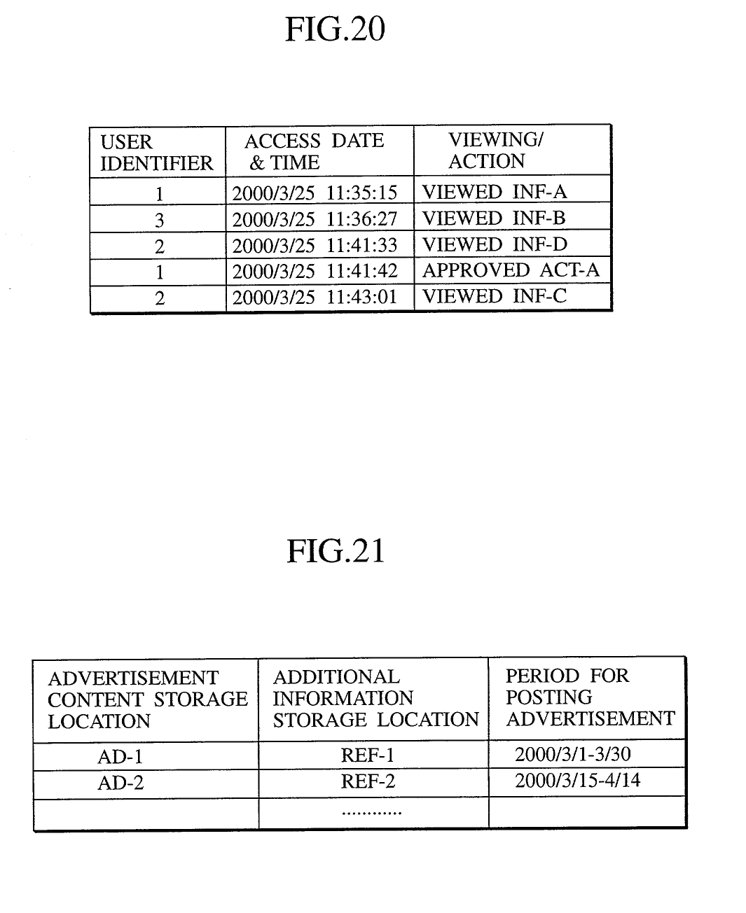

The log management server 1130 sends the access log of each user through the network 1150 to the advertisement providing server 1120 either automatically at a prescribed interval or in response to a request from the advertisement providing server 1120. At the advertisement providing server 1120, the user's access log sent from the log management server 1130 is managed in the user log management unit 1122. As a result, the user log management unit 1122 manages the latest access log. FIG. 20 shows an example of the user's access log managed by the user log management unit 1122.

Note that the advertisement providing server 1120 may play the role of the log management server 1130. Also, the advertisement providing server 1120 can be one of the information service providing servers.

Next, the processing for providing the advertisement by using the access log of the user at the advertisement providing server 1120 will be described.

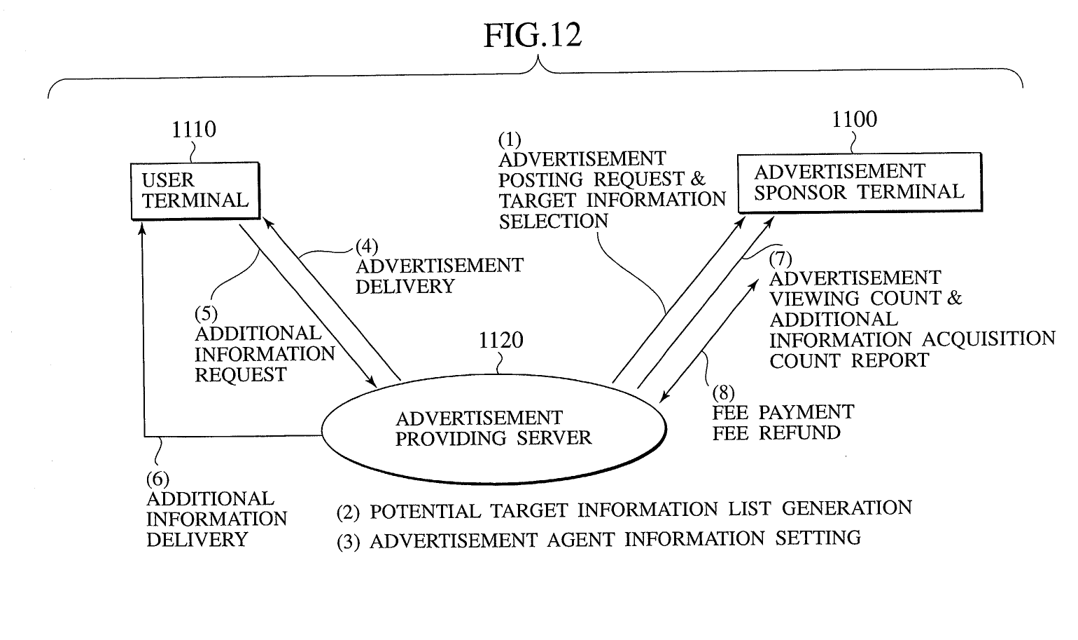

FIG. 12 shows the overall flow of the advertisement providing processing. In response to the advertisement posting request made by the advertisement sponsor, the generation of the potential target information list and the setting of the advertisement agents are carried out, and the advertisement and the additional information are provided to the user. Also, the advertisement viewing count and the additional information acquisition count are counted and reported to the advertisement sponsor, and the payment of the fee is received from the advertisement sponsor.

In the following, the flow of this processing will be described in further detail along FIG. 12. Note that the advertisement to be provided to the user will be referred to as advertisement information and information that can be viewed by the user will be referred to as viewing information in the following.

(1) The advertisement sponsor sends the advertisement information that is to be posted to the advertisement providing server 1120 using the advertisement sponsor terminal 1100. At this point, the advertisement content, the period for posting, the additional information storage location, etc., are also notified. At the advertisement providing server 1120, the advertisement information sent from the advertisement sponsor terminal 1100 is managed at the advertisement information management unit 1121. An example of the advertisement information to be managed by the advertisement information management unit 1121 is shown in FIG. 21.

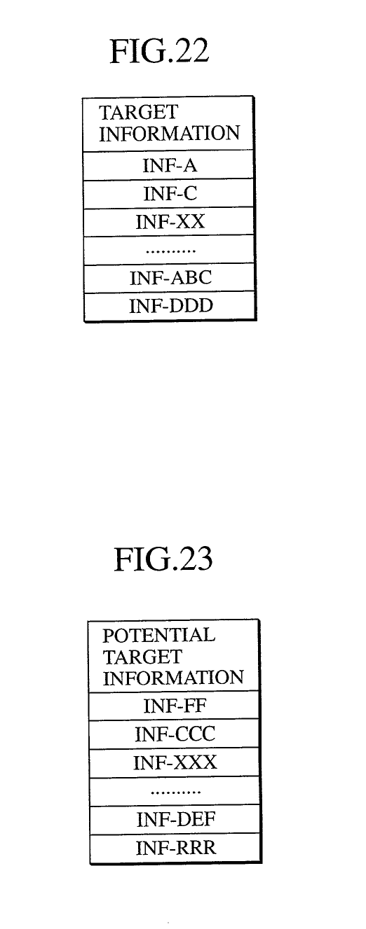

In addition, the advertisement sponsor selects one (or more) target information (Web site information page, product page, etc.) that is related to the advertisement information to be posted and sends it to the advertisement providing server 1120 at a time of requesting the advertisement posting. Note that this target information may be selected and notified by a deputy or agency of the advertisement sponsor. An example of the target information is shown in FIG. 22.

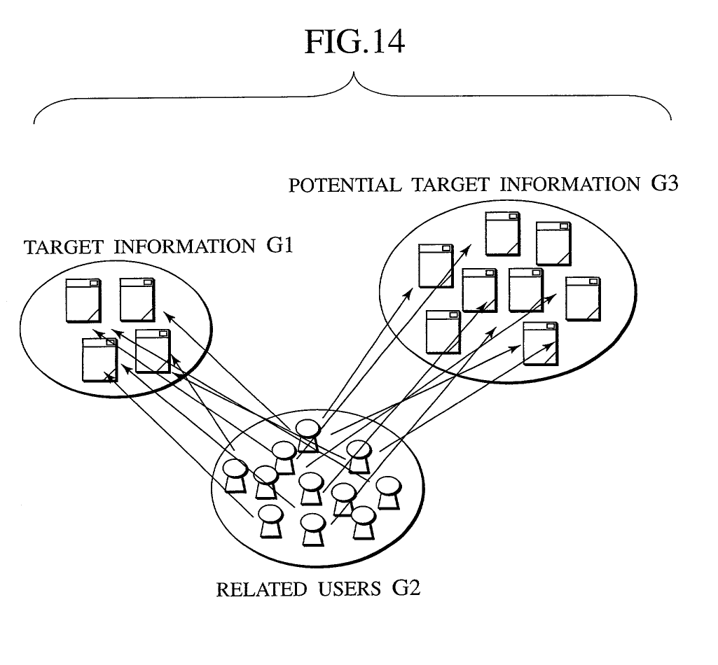

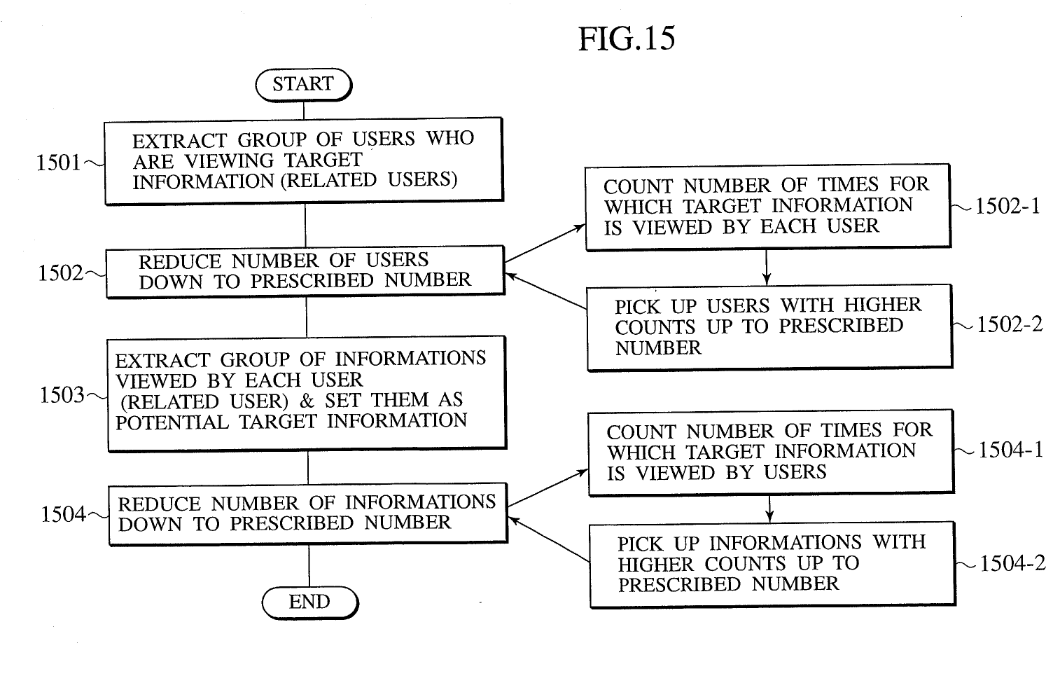

(2) The potential target information generation unit 1123 of the advertisement providing server 1120 extracts the potential target information, which corresponds to G3 of FIG. 3 described above when the target information is G1. FIG. 14 shows a basic principle of the potential target information extraction processing conceptually, and FIG. 15 shows a processing flow of the potential target information extraction processing.

First, a group of users (related users) G2 who are viewing the target information G1 are extracted according to the collected access logs of the users (step 1501). When the number of the extracted users (related users) is large, it is reduced down to a prescribed number (step 1502). This is done by counting the number of times for which the target information is viewed by each extracted user (step 1502-1), and narrowing the related users by picking up users with higher counts up to the prescribed number (step 1502-2).

Next, a group of informations viewed by the related users extracted above other than the target information G1 are collected according to the collected access logs of the users (step 1503). This is the potential target information G3 with respect to the target information G1. Here, when the number of the extracted informations is large, it is reduced down to a prescribed number (step 1504). This is done similarly as in the case of reducing the number of the related users described above (steps 1504-1, 1504-2). An example of the potential target information is shown in FIG. 23.

(3) The user log management unit 1123 of the advertisement providing server 1120 sets virtual users (which will be referred to as advertisement agents) who have the additional information, the target information and the potential target information as the viewing information, and adds these advertisement agents to the user access logs. Namely, the advertise agents are set as if the additional information and the target information or the potential target information is viewed by the advertisement agents. Here, the advertisement agent is allocated with a virtual fixed user identifier. Also, at this point, the advertisement agent is given an advertisement attribute, and the additional information is also given an advertisement attribute.

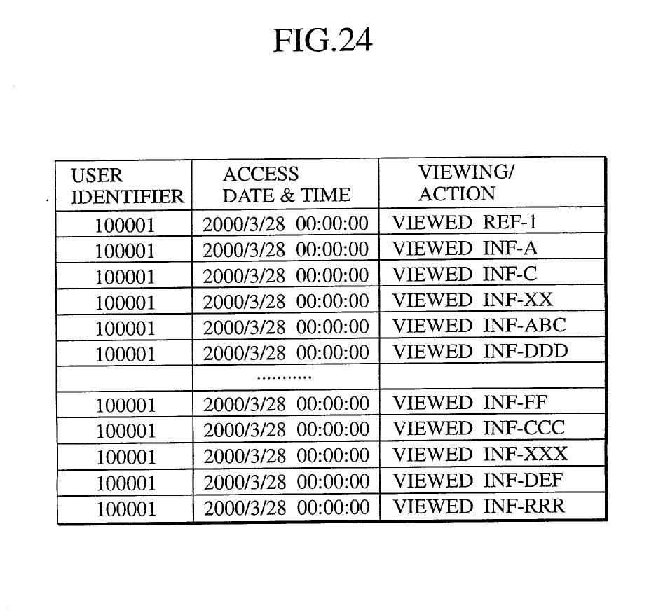

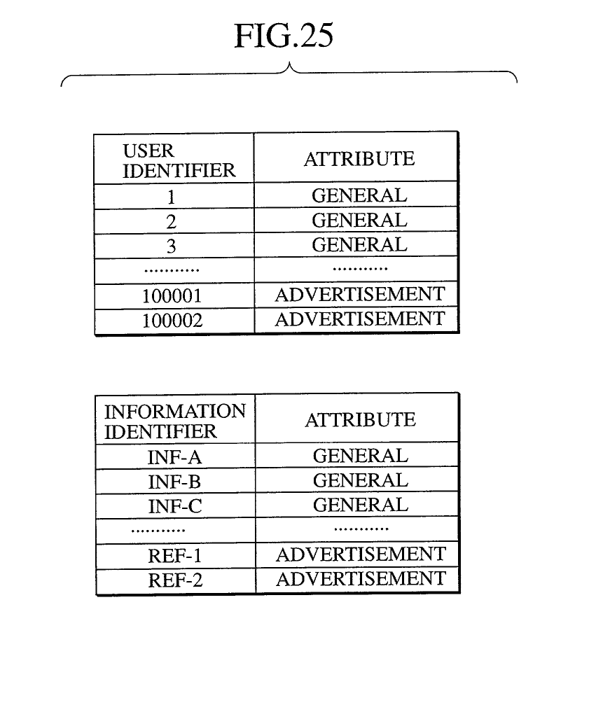

FIG. 24 shows an example of the virtual access log of the advertisement agents obtained from the information shown in FIGS. 11 to 13. Also, FIG. 25 shows an example of the attribute setting with respect to the user identifier and the information identifier. Note that there can be cases where the potential target information is omitted so that the advertisement has only the additional information and the target information as the viewing information. It is also possible to set both the target information and the potential target information along with the additional information as the viewing information.

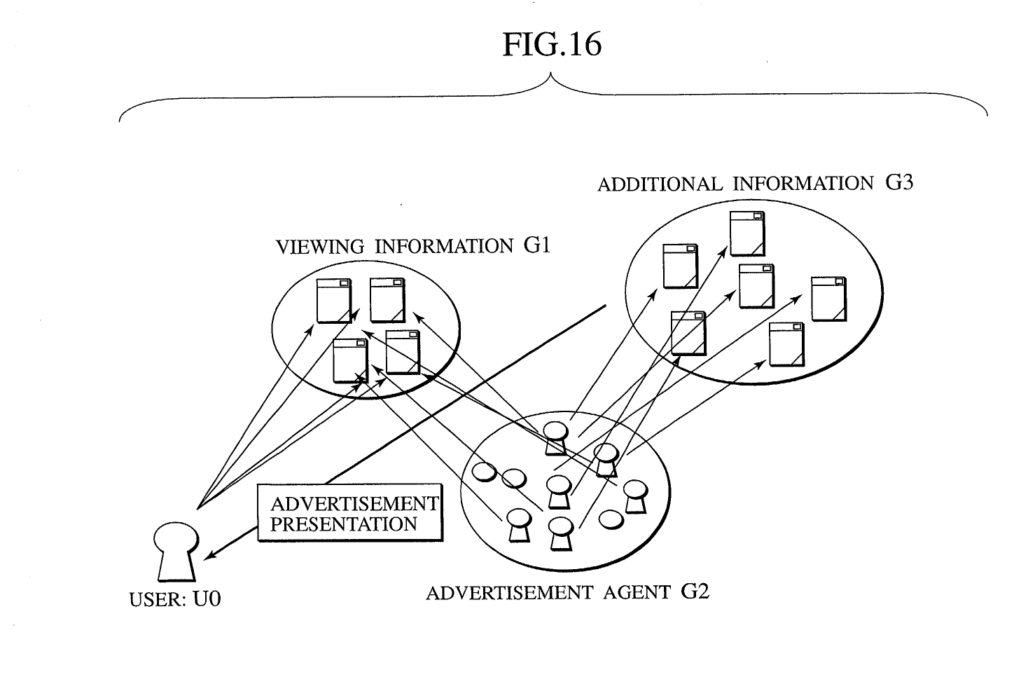

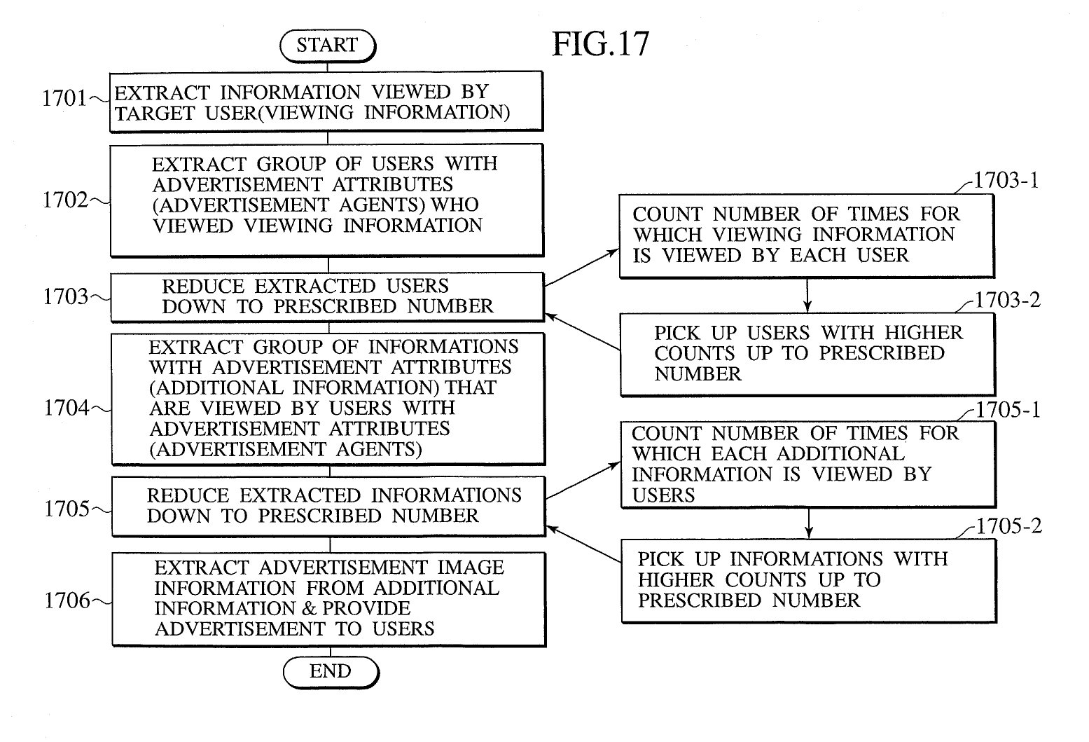

(4) The advertisement information selection unit 1124 of the advertisement providing server 1120 selects the advertisement information appropriate for the user basically according to the algorithm of FIG. 3 described above, from the advertisement information that is still within the advertisement posting period. Here, the related users to be included in G2 are set to be the users who have the advertisement attributes, i.e., the advertisement agents alone, and the presentation information to be included in G3 is set to be the information which has the advertisement attribute, i.e., the additional information alone. Then, the advertisement content of the advertisement information that is managed in association with the extracted additional information is obtained, the advertisement information and the additional information are linked, and the advertisement content is provided to the user. FIG. 16 shows a basic principle of the advertisement providing processing conceptually, and FIG. 17 shows a processing flow of the advertisement providing processing.

First, the information (viewing information) G1 viewed by the user who is the advertisement providing target is extracted from the access logs of all users (including the access logs of the virtual advertisement agents) (step 1701). Then, a group of users (advertisement agents) G2 with the advertisement attributes who viewed the viewing information are extracted (step 1702). More specifically, a group of users (related users) other than the advertisement providing target user who viewed the viewing information G1 are extracted from all the access logs, and then a group of users who have the advertisement attributes (advertisement agents) are extracted from these extracted users. When the number of the extracted users (advertisement agents) is large, it is reduced down to a prescribed number (step 1703). This is done by counting the number of times for which the viewing information is viewed by each extracted user (step 1703-1), and narrowing the related users by picking up users with higher counts up to the prescribed number (step 1703-2).

Next, a group of informations with the advertisement attributes (additional information) G3 that are viewed by the extracted users with the advertisement attributes (advertisement agents) are extracted (step 1704). More specifically, a group of informations viewed by the advertisement agents G2 are extracted, and a group of informations with the advertisement attributes (additional information) are extracted from these extracted informations. Here, when the number of the extracted informations is large, it is reduced down to a prescribed number (such as a number necessary for display, for example) (step 1705). This is done similarly as in the case of reducing the number of the users described above (steps 1705-1, 1705-2).

Next, the advertisement content of the advertisement information that is managed in association with the extracted additional information is obtained, the additional information is linked to the advertisement content, and the advertisement content is sent to the user terminal 1110 of the advertisement providing target user (step 1706).

In this way, the appropriate advertisement information is provided to the user according to the viewing information (access log) of each user. Note that the advertisement information can be provided to the user at a timing of the request from the user or at a prescribed interval from the advertisement providing server 1120, for example.

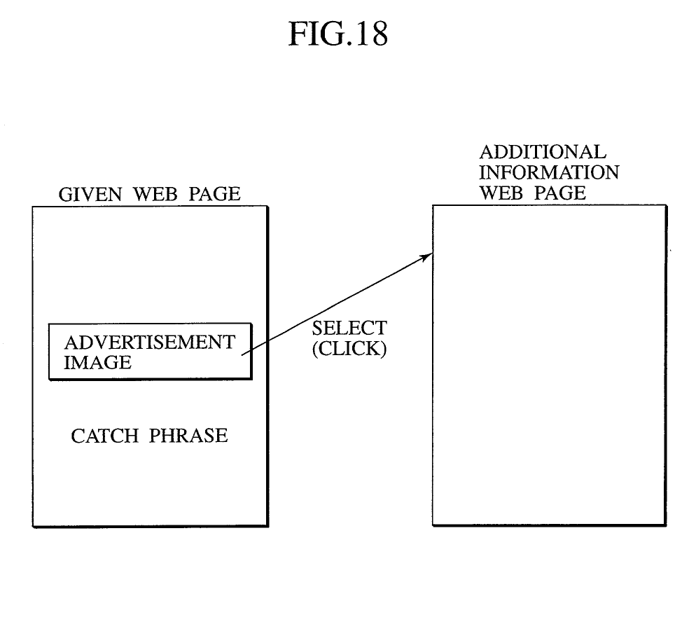

(5) The user views the advertisement content by utilizing the browser of the user terminal 1110, and if the user is interested in what is advertised, the user requests the additional information to the advertisement providing server 1120 and acquires the additional information. FIG. 18 shows an exemplary way of acquiring the additional information.

(6) The advertisement providing count management unit 1125 of the advertisement providing server 1120 records the number of times for which the advertisement is viewed by the users (advertisement viewing count) and the number of time for which additional information is acquired by the users (additional information acquisition count). Also, the advertisement fee calculation unit 1126 calculates an advertisement fee according to the advertisement viewing count, the additional information acquisition count, etc.

The advertisement providing server 1120 provides a prescribed report and demands the payment of the advertisement fee to the advertisement sponsor through the advertisement sponsor terminal 1100 according to the advertisement viewing count, the additional information acquisition count, and the fee calculation result, at a prescribed timing or after the end of the advertisement posting period.

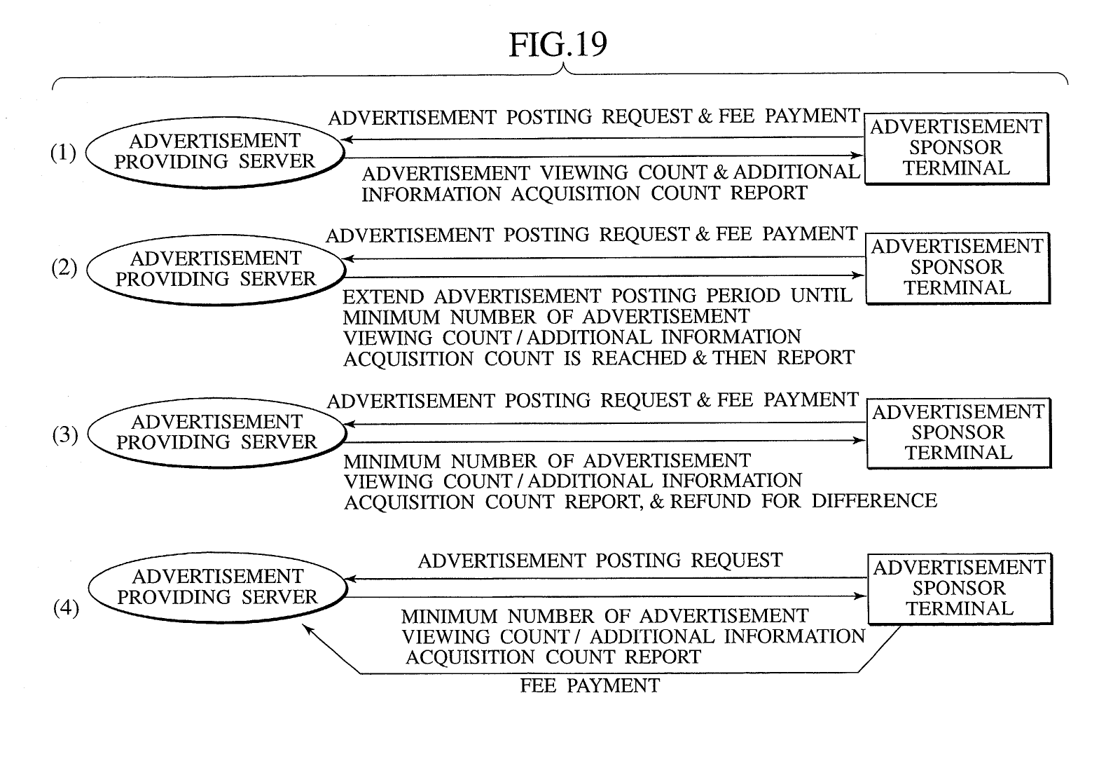

FIG. 19 shows various possible ways of the advertisement fee payment. A part (1) of FIG. 19 is a method in which the advertisement fee is determined when the posting of the advertisement is decided. It is possible to adopt such a conventional payment method, but this embodiment is more suitable for a model in which the advertisement fee is determined in view of the advertisement viewing count and the additional information acquisition count according to the agreement. Parts (2), (3) and (4) of FIG. 19 show examples of this model.

A part (2) of FIG. 19 is a method in which the minimum number of the advertisement viewing count and/or the additional information acquisition count is guaranteed and the fee for that minimum number is paid in advance when the posting of the advertisement is decided, and if the minimum number is not reached, the advertisement posting period is extended until the minimum number is reached.

A part (3) of FIG. 19 is a method in which the minimum number of the advertisement viewing count and/or the additional information acquisition count is guaranteed and the fee for that minimum number is paid in advance when the posting of the advertisement is decided, and if the minimum number is not reached, a part of the fee for a difference is refunded according to the agreement.

A part (4) of FIG. 19 is a method in which the fee is paid after the advertisement posting period has ended, according to the advertisement viewing count and the additional information acquisition count.

In the following, the concrete example of this embodiment will be described. Here, the exemplary case of the banner advertisement in the WWW using some Web service that is providing product information on the Internet will be described. It is assumed that the user is viewing various Web pages through this Web service.

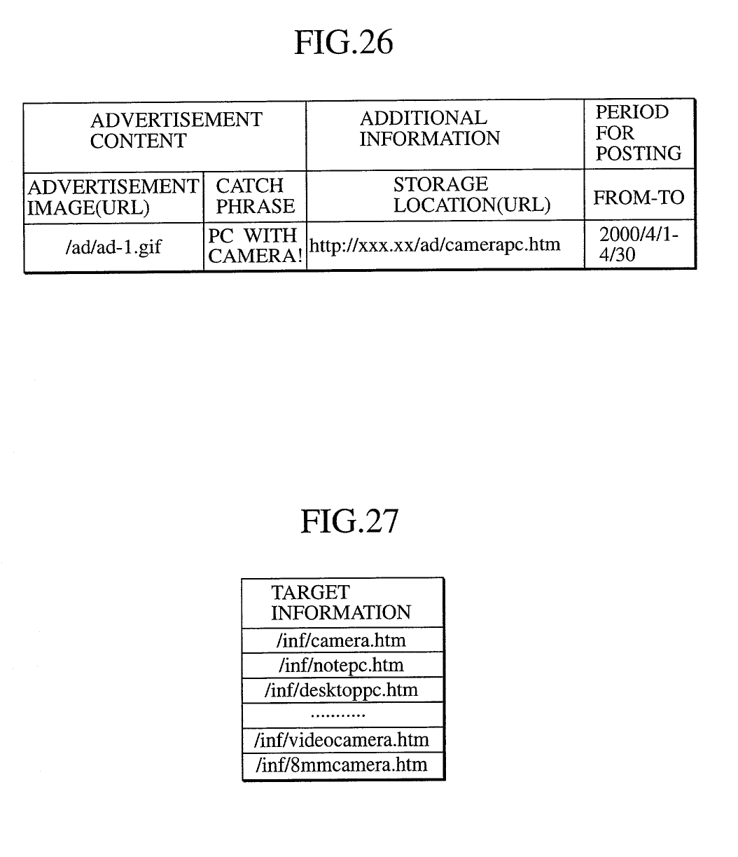

The advertisement sponsor or its deputy prepares the banner advertisement for a new portable PC with a camera, and requests the posting of the advertisement. At this point, the advertisement content (advertisement image, catch phrase) and a URL of the additional information to be viewed by the user who is interested in the advertised product are set. Usually, this setting is made in a form of a link information with respect to the advertisement content. FIG. 26 shows an example of the advertisement information.

In addition, the advertisement sponsor or its deputy selects Web pages (target information) that are related to this advertisement from the pages provided at this Web service. Here, it is assumed that Web pages shown in FIG. 27 are selected.

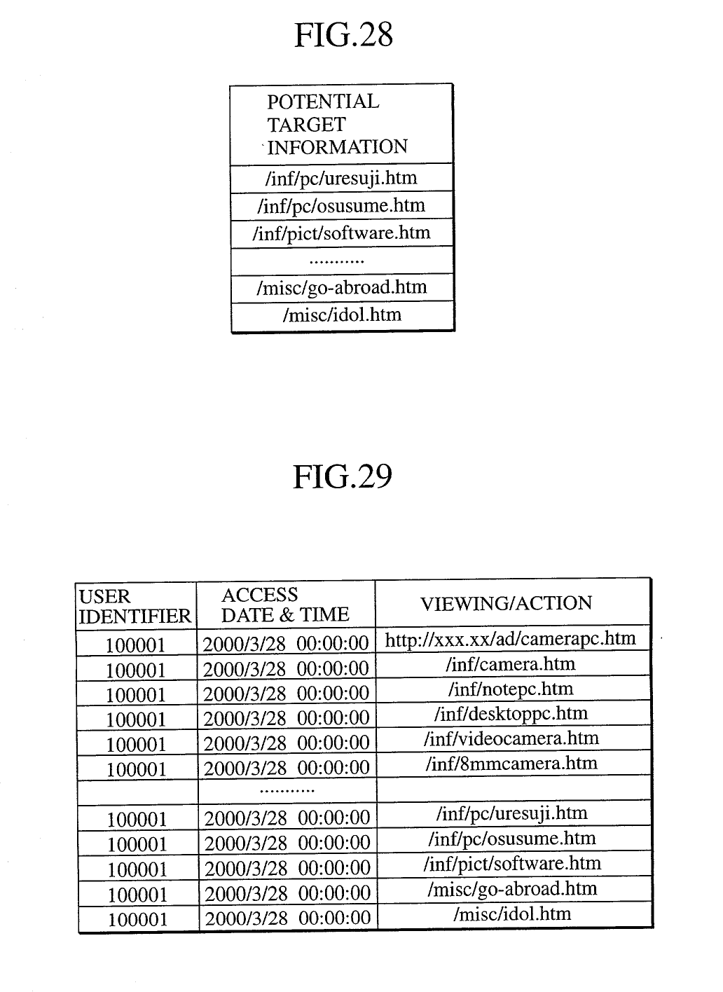

At the advertisement providing server 1120, pages (potential target information) related to the selected Web pages are extracted first. Namely, the group of Web pages shown in FIG. 27 are set as G1, and the related users G2 are extracted, and then the potential target information G3 is extracted. Here, the access logs to be used in extracting G2 from G1 and G3 from G2 are the access logs for accesses made within this Web service. FIG. 28 shows an example of the potential target information.

In the case where the target information is recorded in the access log of the advertisement agent as information directly related to the advertisement that is recorded as the additional information, it is possible to transmit the advertisement to the client who accessed that target information. Similarly, in the case where the potential target information is recorded in the access log of the advertisement agent, it is possible to transmit the advertisement to other clients who accessed that potential target information related to the target information but who have not accessed the target information itself. In other words, it is also possible to deliver the advertisement to those clients who are potentially likely to have interests in that advertisement as well.

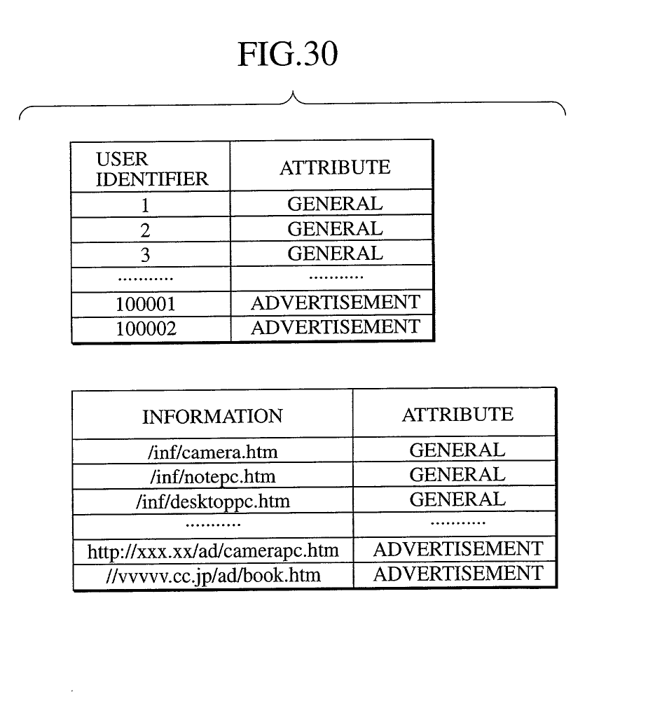

Next, the user IDs for the advertisement agents are allocated, and the access logs indicating that users with these user IDs have viewed the additional information URL, the target information URL, and the potential target information URL are created. Here, the access log of the advertisement agent appears as shown in FIG. 29. Also, at this point, the advertisement attributes are set with respect the user IDs of the advertisement agents and the additional information URLs as shown in FIG. 30.

When a general user utilizes this Web service and attempts to view the advertisement, the advertisement providing server 1120 is activated to make the advertisement presentation. At this point, users to be included in G2 are set to be the users with the advertisement attributes, i.e., the advertisement agents alone, and informations to be included in G3 are set to be the informations with the advertisement attributes, i.e., the additional information alone. The advertisement content of the advertisement information that is managed in association with the extracted additional information is obtained, and only the advertisement is presented.

The user checks the displayed advertisement, and if necessary, acquires the additional information. More specifically, the user do this by clicking the advertisement image as shown in FIG. 18. The advertisement providing server 1120 stores a record for that access as well.

As for the fee payment, several options as shown in FIG. 19 are provided. In general, the fee is to be paid at a time of the advertisement posting request, but three other options are also provided here.

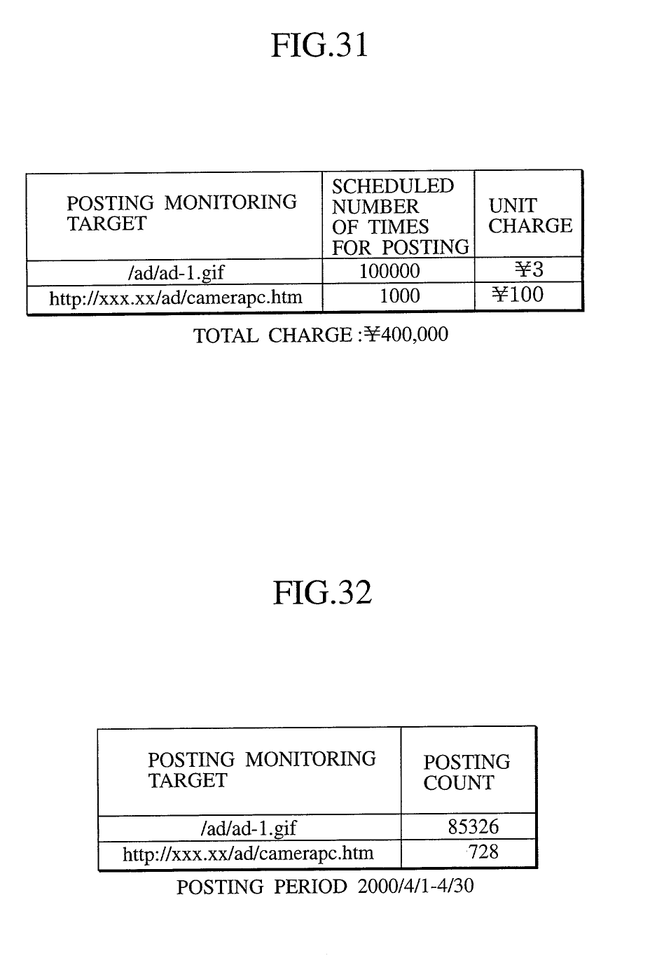

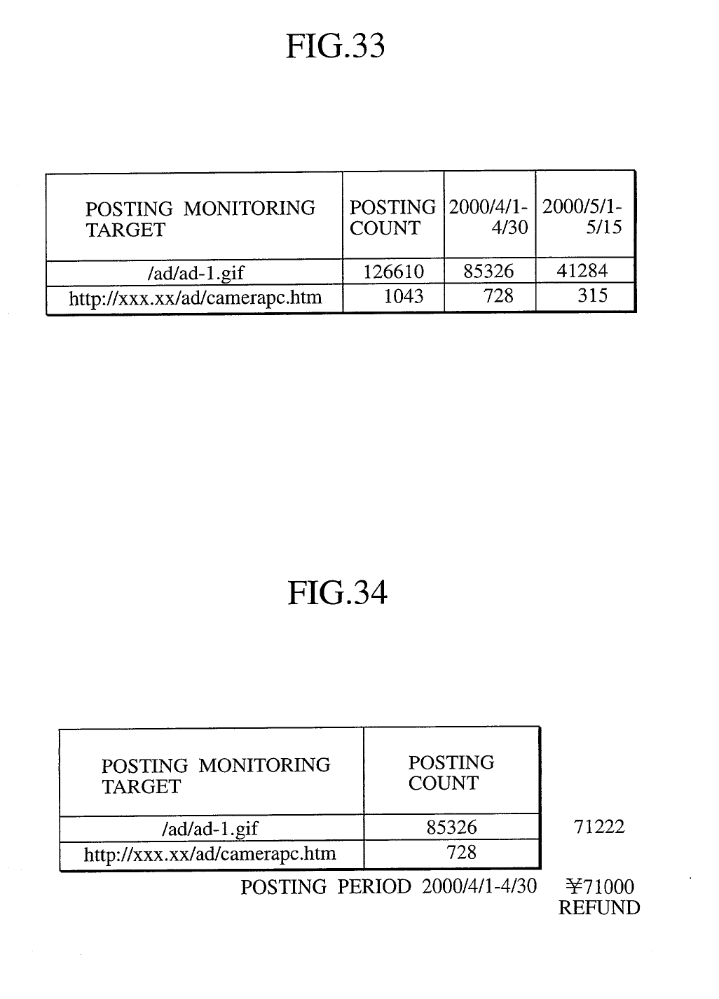

In the case of using the option for posting the advertisement until the guaranteed number of the advertisement viewing count/additional information acquisition count is reached, if the fee list shown in FIG. 31 is used and the guaranteed number is not reached as shown in FIG. 32, the posting period will be extended until the guaranteed number is reached as shown in FIG. 33. In this example, the original posting period is from April 1 to April 30, and this posting period is extended to May 15.

In the case of using the option for refunding a difference when the guaranteed number of the advertisement viewing count/additional information acquisition count is not reached, if the fee list of FIG. 31 is used and the guaranteed number is not reached, the fee corresponding to the difference is refunded as shown in FIG. 34. In this example, ¥71,000 is refunded by rounding off the lower three digits.

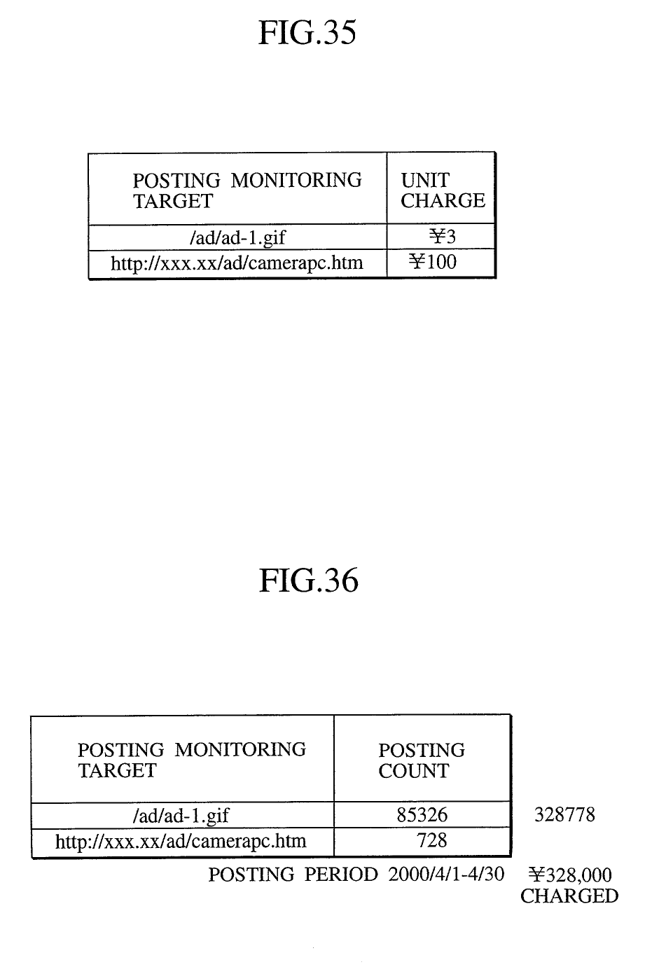

In the case of using the option for determining the fee according to the actual advertisement viewing count/additional information acquisition count, if the fee list shown in FIG. 35 is used, a unit charge per one advertisement viewing is ¥3 and a unit charge per one additional information acquisition is ¥100, and if the the actual advertisement viewing count and additional information acquisition count are as shown in FIG. 36 as a result of posting the advertisement from Aprill to April 30, the fee is calculated to be ¥328,000 by rounding off the lower three digits.

As described, according to this second embodiment, in the advertisement posting on the interactive media, the users who are likely to be interested and the users who are potentially likely to be interested can be discovered and appropriate advertisement information can be selected and provided according to the latest access logs of the users. As a result, it becomes possible to increase the additional information acquisition count even when the advertisement viewing count is the same. Consequently, by using the advertisement fee system based on the advertisement viewing count and the additional information acquisition count, it becomes possible to increase the income considerably.

Also, according to this second embodiment, by setting a plurality of target informations, the users who viewed a plurality of specific contents can be selected as the advertisement providing targets rather than the users who viewed only one specific content. Also, by determining the advertisement providing targets according to the potential target information in addition to the target information, it is possible to widen the scope of the advertisement providing targets.

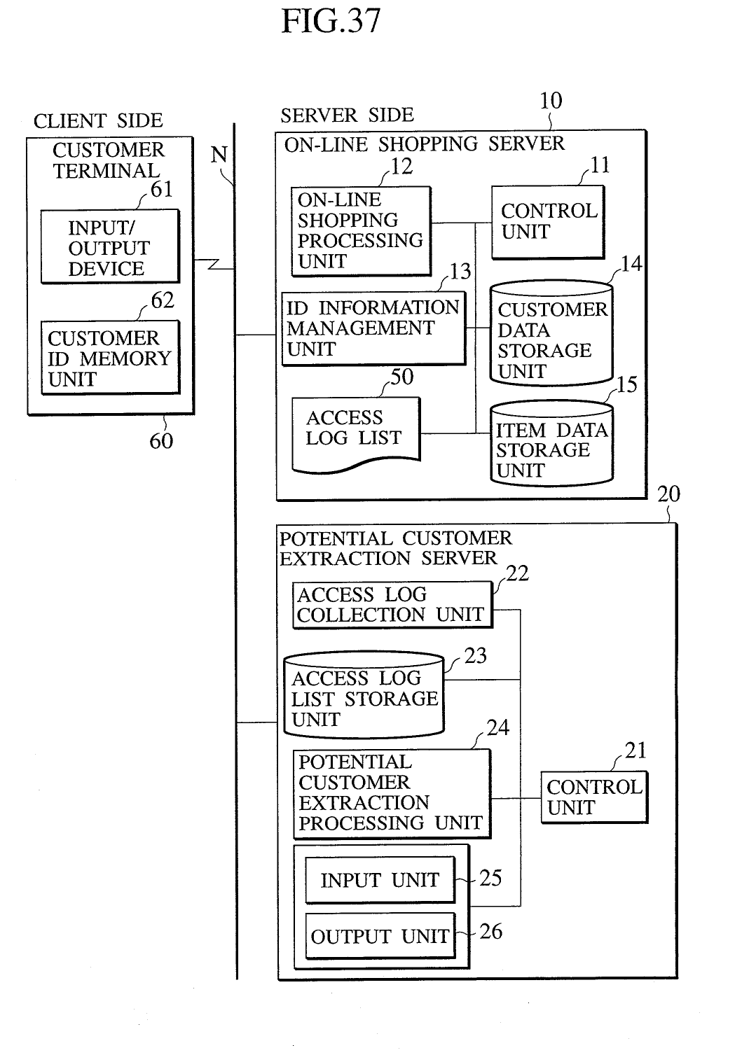

Referring now to FIG. 37 to FIG. 47, the third embodiment of the present invention which is directed to the advertisement providing scheme will be described in detail.

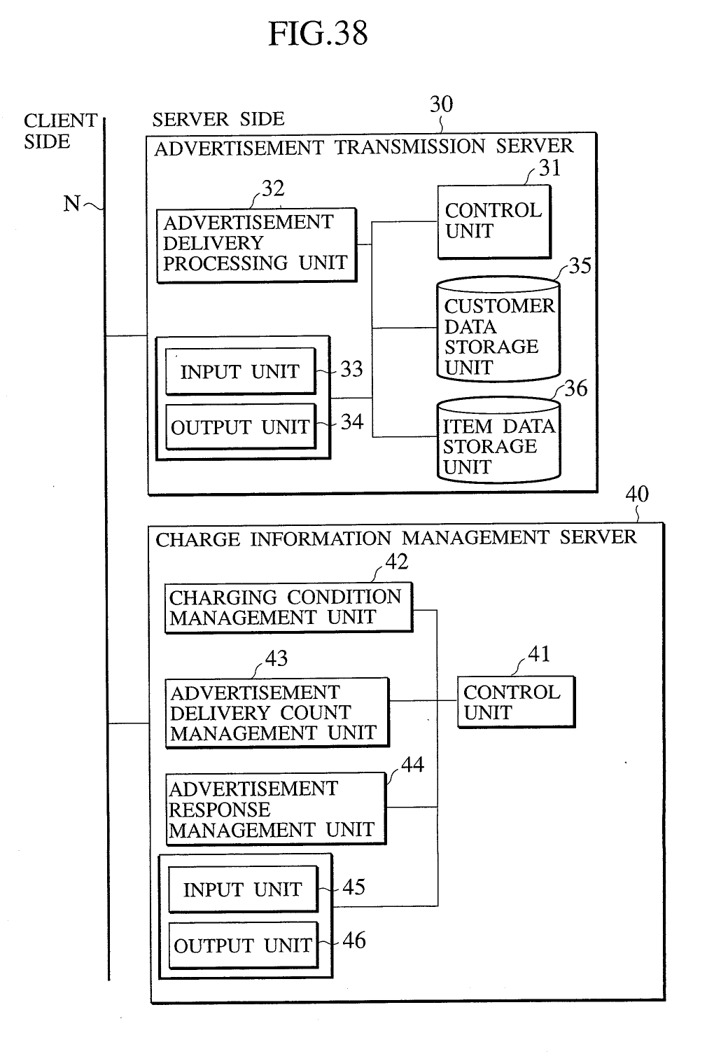

FIG. 37 and FIG. 38 show an exemplary configuration of an advertisement delivery system according to this embodiment.

In the configuration of FIG. 37 and FIG. 38, a client side comprises customer terminals 60 each of which is a Web accessible device such as PC, a digital interactive TV set, a telephone, or a cellular phone, etc., and each of which has an input/output device 61 for enabling the viewing of item information, the purchasing of items and the display of the advertisement, and a customer ID memory unit 62 for storing a customer ID.

The input/output device 61 has an output unit using a display, a printer, a TV display screen, a liquid crystal display screen, etc., and an input unit using a mouse, various pointing devices, keyboard, infrared remote controller, push keys of the cellular phone, etc.

The customer ID memory unit 62 stores a customer ID that is assigned from a on-line shopping server 10.

On the other hand, a server side comprises an on-line shopping server 10 for displaying item information or receiving item purchase order according to a request from the customer terminal 60, a potential customer extraction server 20 for extracting potential customers of an advertisement delivery target item from access logs at the on-line shopping server 10, an advertisement transmission server 30 for displaying or delivering the advertisement with respect to the customer terminal 60, and a charge information management server 40 for managing charge information with respect to the advertisement delivery.

The customer terminals 60, the on-line shopping server 10, the potential customer extraction server 20, an advertisement transmission server 30 and the charge information management server 40 are interconnected through a network N such as the Internet.

The on-line shopping server 10 is an EC server or the like that can view the item information and actually purchase items through network sites such as Amazon.com (http://www.amazon.com/), Outpost.com (http://www.outpost.com/) and Rakuten Mall (http://www.rakuten.co.jp/). The on-line shopping server 10 comprises an on-line shopping processing unit 12 for receiving requests such as item information viewing request or purchasing request from the customer terminals 60 and carrying out the information display or purchasing order placing processing, an access log list 50 for recording a log of accesses (viewing/purchasing) with respect to items such as viewing/purchasing of items, an ID information management unit 13 for issuing the customer ID to the customer terminal 60 and storing the customer ID information into a customer data storage unit 14, an item data storage unit 15 for storing item information and item IDs, and a control unit 11 for controlling various units constituting the on-line shopping server 10.

Here, the item is information, product, etc., that can be viewed, put into a shopping cart, or purchased through the customer terminal 60, which can be uniquely identified by an Item ID such as URL of the Web, product code, etc.

The customer ID is a globally unique identifier, and the generation of a new customer ID and the checking of an existing ID are carried out at the ID information management unit 13.

The potential customer extraction server 20 comprises an access log collection unit 22 for collecting the access log list 50 from one or a plurality of on-line shopping servers 10, an access log list storage unit 23 for storing the access log list 50 for a prescribed period of time, a potential customer extraction processing unit 24 for carrying out an extraction of potential customers according to a potential customer extraction request received at an input unit 25 on a basis of the access logs stored in the access log list storage unit 23, an output unit 26 for outputting a list of the extracted potential customers, and a control unit 21 for controlling various units constituting the potential customer extraction server 20.

The advertisement transmission server 30 comprises an output unit 34 for transmitting specified advertisement target item IDs to the potential customer extraction server 20, an input unit 33 for receiving the potential customer list, an advertisement delivery processing unit 32 for carrying out an advertisement transmission with respect to the customer terminals 60 of the customer IDs described in the potential customer list, a customer data storage unit 35 similar to the customer data storage unit 14 of the online shopping server 10, an item data storage unit 36, and a control unit 31 for controlling various units constituting the advertisement transmission server 30.

The charge information management server 40 is a management server for charging and demanding the fee payment to a company that is the advertisement sponsor of the item, with respect to the advertisement transmission, the reaction to the advertisement (such as clicking of a banner), the viewing of the item information, the purchasing of the item, etc. The charge information management server 40 comprises a charging condition management unit 42, an advertisement delivery count management unit 43, an advertisement response management unit 44, an input unit 45, an output unit 46 and a control unit 41.

The charging condition management unit 42 manages an advertisement charging policy, transaction counts (advertisement delivery count, advertisement response count), and contracted fees, such that the transaction counts (advertisement delivery count, advertisement response count) and the contracted fees can be read out by using the item ID and the advertisement charging policy as keys.

The advertisement charging policy includes the following.

A meter rate charging according to the advertisement delivery count: a fee is calculated as the advertisement delivery count of the contract target item x a unit charge per one delivery.

A flat rate charging for a prescribed advertisement delivery count: a fixed fee is charged on a condition that the advertisement delivery count of the contract target item reaches to a prescribed number.

A meter rate charging according to the advertisement response count: a fee is calculated as the advertisement response count originating from the advertisement delivery of the contract target item x a unit charge per one response.

A flat rate charging for a prescribed advertisement response count: a fixed fee is charged on a condition that the advertisement response count originating from the advertisement delivery of the contract target item reaches to a prescribed number.

A charging by the combination of the above: a fixed fee is set as a flat rate on a condition that the advertisement delivery count reaches to a prescribed number, an additional meter rate charging is made when the advertisement delivery count exceeds a prescribed number or a refund is made when the advertisement delivery count fails to reach a prescribed number according to a difference between the actual advertisement delivery count and a prescribed number, etc.

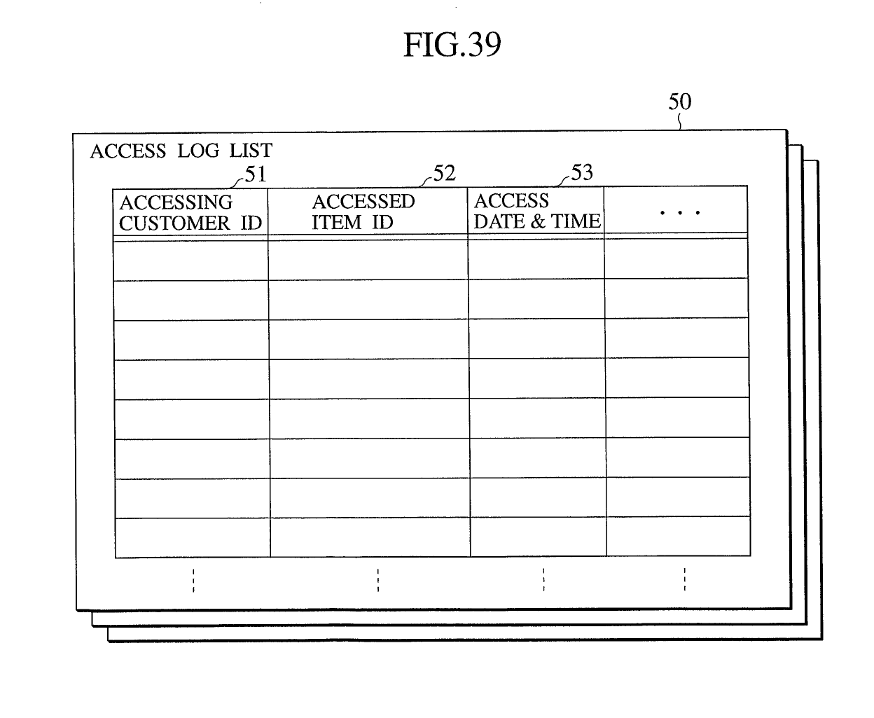

FIG. 39 shows the access log list 50 generated at the on-line shopping server 10 of the advertisement delivery system according to this embodiment.

The access log list 50 describes data in a format containing at least “accessing customer ID 51, accessed item ID 52”, which may also contain supplementary information such as access date and time 53, and can be realized by utilizing the access log of the Web server or as an independent log maintaining function.

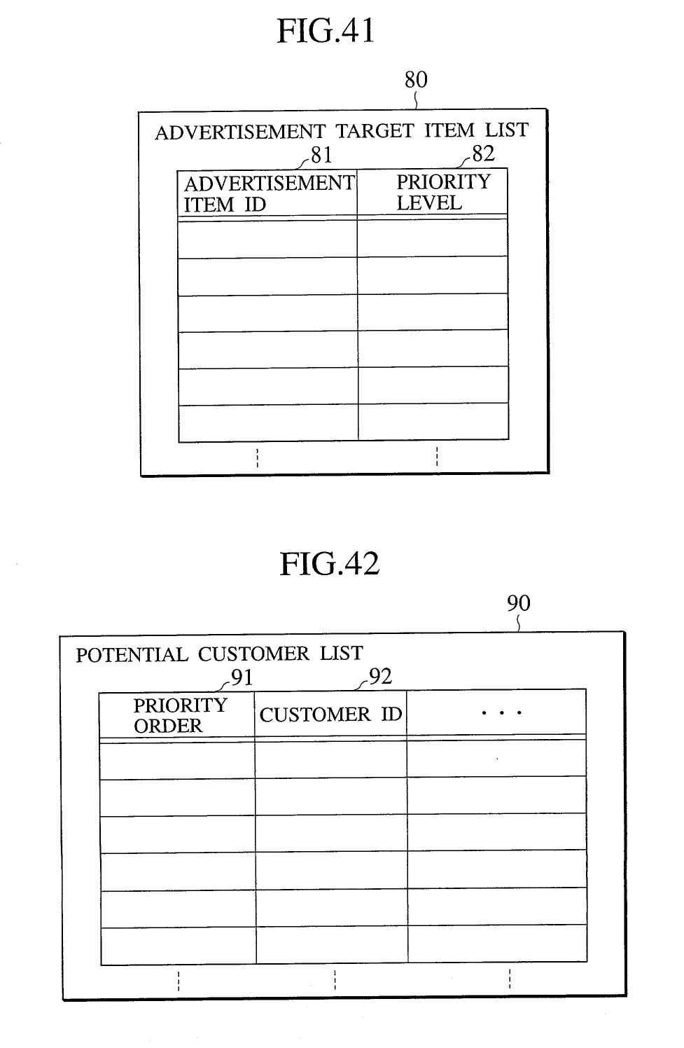

FIG. 41 shows the advertisement target item list 80 to be entered into the potential customer extraction server 20 of the advertisement delivery system according to this embodiment.

The advertisement target item list 80 describes data in a format containing at least “advertisement target item ID 81, priority level 82”, and can be described in the CSV file format using a comma as a delimitor or in an independent description style.

The advertisement target item list 80 may also describe the item IDs of the items related to each advertisement target item, besides the item ID 81 of the advertisement target item.

FIG. 42 shows the potential customer list 90 to be outputted from the potential customer extraction server 20 of the advertisement delivery system according to this embodiment.

The potential customer list 90 describes data in format containing at least “priority order 91, customer ID 92”, and can be described in the CSV file format using a comma as a delimitor or in an independent description style.

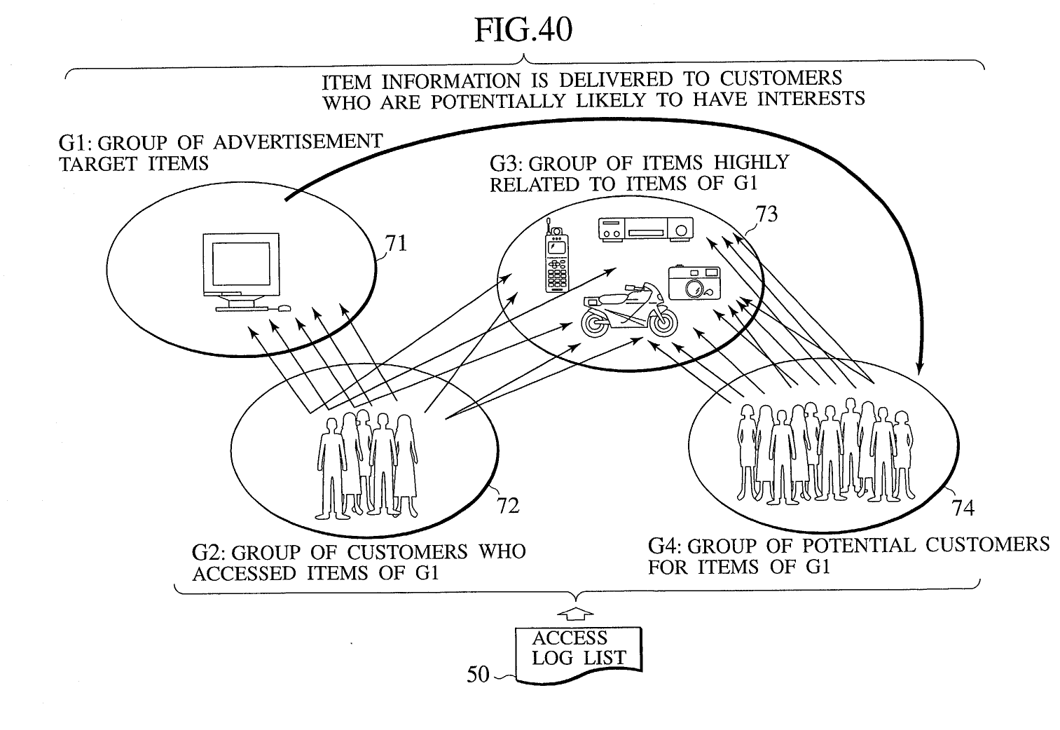

The detailed operations of the various units described above will now be described with references to FIG. 40 and FIG. 43 to FIG. 47.

<Customer ID Assigning>

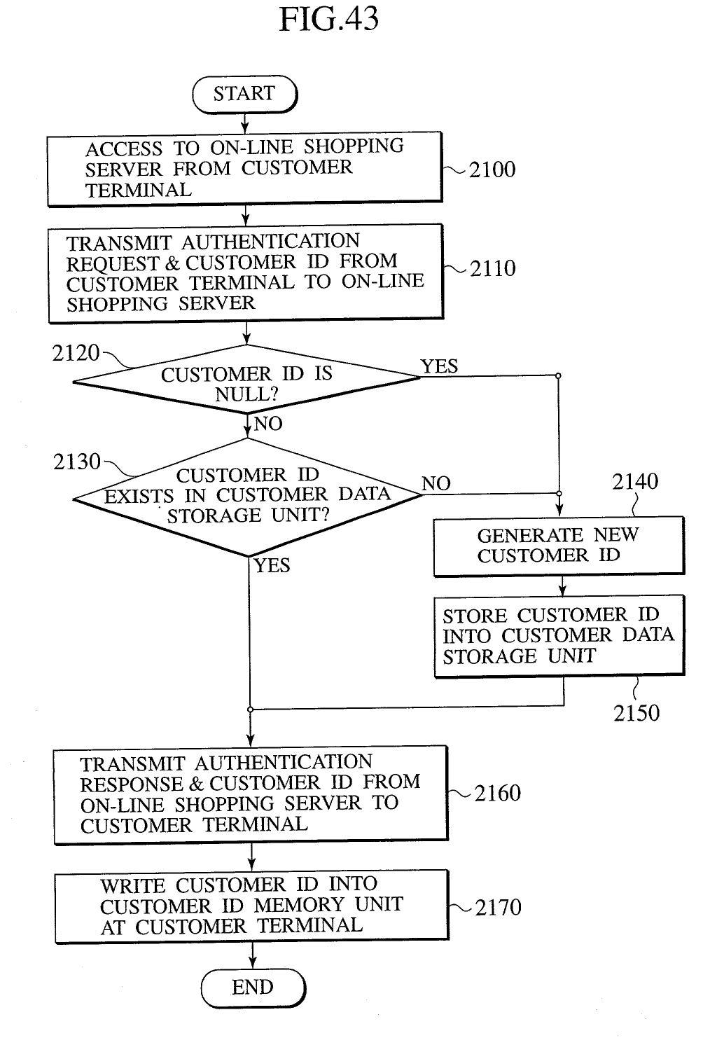

FIG. 43 shows a processing flow for the customer ID assigning operation at the on-line shopping server 10, which proceeds as follows.

(1) The customer accesses the on-line shopping server 10 through the network N such as the Internet by using the customer terminal 60 (step 2100).

(2) After confirming the connection with the on-line shopping server 10, the customer terminal 60 sends the customer ID stored in the customer ID memory unit 62 along with a “customer terminal authentication request”. At this point, if there is no stored customer ID, a NULL code indicating the absence of the stored customer ID will be transmitted (step 2110).

(3-1) Upon receiving the “customer terminal authentication request” and the customer ID, if the customer ID is a NULL code (step 2120 YES), the on-line shopping server 10 generates a new customer ID which is a globally unique identifier at the ID information management unit 13 (step 2140), stores this customer ID into the customer data storage unit 14 (step 2150), and sends this customer ID to the customer terminal 60 along with a “customer terminal authentication response” (step 2160).

(3-2) Upon receiving the “customer terminal authentication request” and the customer ID, if the customer ID is not a NULL code (step 2120 NO), the on-line shopping server 10 checks whether this customer ID exists in the customer data storage unit 14 or not by inquiring to the ID information management unit 13, and if it is not the customer ID that exists in the customer data storage unit 14 (step 2130 NO), the on-line shopping server 10 discards the customer ID received from the customer terminal 60, generates a new customer ID which is a globally unique identifier at the ID information management unit 13 (step 2140), stores this customer ID into the customer data storage unit 14 (step 2150), and sends this customer ID to the customer terminal 60 along with a “customer terminal authentication response” (step 2160).

(3-3) Upon receiving the “customer terminal authentication request” and the customer ID, if the customer ID is not a NULL code (step 2120 NO), the on-line shopping server 10 checks whether this customer ID exists in the customer data storage unit 14 or not by inquiring to the ID information management unit 13, and if it is the customer ID that exists in the customer data storage unit 14 (step 2130 YES), the on-line shopping server 10 sends this customer ID as it is to the customer terminal 60 along with a “customer terminal authentication response” (step 2160).

(4) Upon receiving the “customer terminal authentication response” and the customer ID, the customer terminal 60 stores the received customer ID into the customer ID memory unit 62 (step 2170).

In this series of processing, it is also possible to store and manage a password along with the customer ID at the ID information management unit 13 such that the password check is also carried out in the customer terminal authentication request processing of (2) and (3), so as to improve the security of the customer ID.

<Access Log Generation>

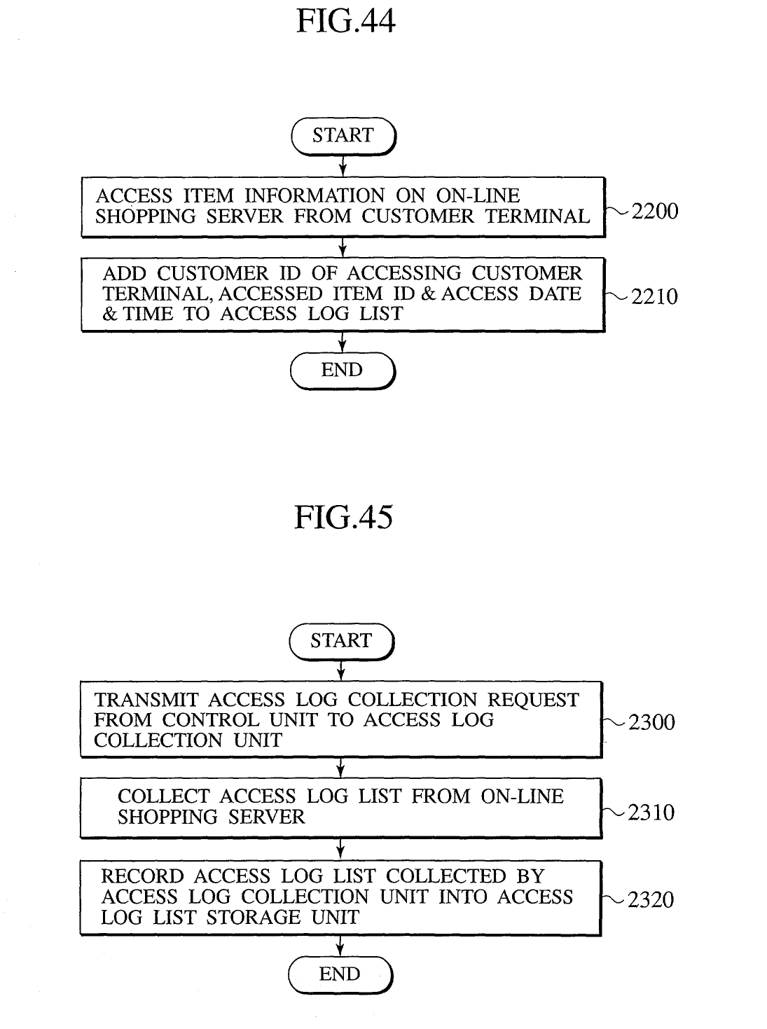

FIG. 44 shows a processing flow for the access log generation operation at the on-line shopping server 10, which proceeds as follows.

(1) The customer transmits a request for viewing of an item information or purchasing of an item on the on-line shopping server 10 through the network N such as the Internet by using the customer terminal 60 (step 2200).

(2) The access log is added to the access log list 50 in a format containing at least the customer ID of the accessing customer terminal 60 and the item ID of the viewing/purchasing target item (step 2210).

The information to be recorded in the access log is not necessarily limited to what is described above, and it is also possible to record information as to whether it is a viewing or a purchasing, which can be utilized as a parameter for determining the priority order at a time of the potential customer extraction operation to be described below.

<Access Log Collecting>

FIG. 45 shows a processing flow for the access log collecting operation at the potential customer extraction server 20, which proceeds as follows.

(1) At the potential customer extraction server 20, an access log collection request is transmitted from the control unit 21 to the access log collection unit 22 at a prescribed timing, and the access log collecting operation is started (step 2300).

(2) At the potential customer extraction server 20, the access log collection unit 22 collects the access log list 50 on the on-line shopping server 10 through the network N using a protocol such as FTP GET (step 2310).

(3) When the access log list 50 is collected from the on-line shopping server 10, the access log collection unit 22 stores it into the access log list storage unit 23. At this point, the access log is stored in such a format that the access log for viewing/purchasing made by the customer can be read out by using the customer ID as a key and the access log for viewing/purchasing of the item can be read out by using the item ID as a key (step 2320).

Note that the collecting target in the collecting operation of (2) is not necessarily limited to a single online shopping server 10, and can be a plurality of on-line shopping servers 10. Also, this operation is not necessarily limited to a scheme in which the access log collection is initiated by the access log collection unit 22, and can be a scheme in which the access log is transmitted from the on-line shopping server 10 to the access log collection unit 22 periodically or whenever an access was made.

<Potential Customer Extraction>

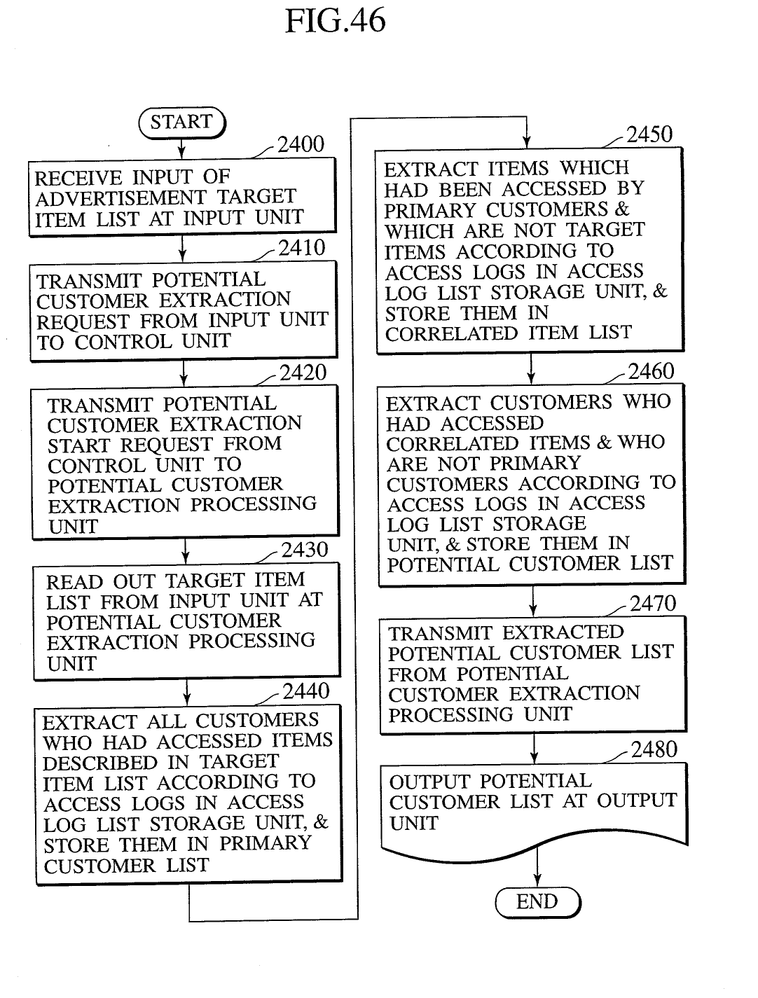

FIG. 46 shows a processing flow for the potential customer extraction operation at the potential customer extraction server 20, which proceeds as follows.

(1) At the potential customer extraction server 20, the input unit 25 receives an input of the advertisement target item list along with the “potential customer extraction request” (step 2400).

The information contained in the advertisement target item list is not necessarily limited to the item IDs of the actual advertisement target items alone, and may include item IDs of items related to the advertisement target items specified by the advertisement sponsor.

(2) Upon receiving the potential customer extraction request, the input unit 25 transmits the potential customer extraction request to the control unit 21, and the potential customer extraction operation is started (step 2410).

(3) Upon receiving the potential customer extraction request, the control unit 21 transmits a potential customer extraction start request to the potential customer extraction processing unit 24 (step 2420).

(4) Upon receiving the potential customer extraction start request, the potential customer extraction processing unit 24 reads out the advertisement target item list from the input unit 25, and sets all the item IDs in the advertisement target item list as G1: a group 71 of advertisement target items as shown in FIG. 40 (step 2430).

(5) At the potential customer extraction processing unit 24, the access logs for viewing/purchasing of the items with the item IDs in G1 made by the customers in the past are acquired from the access log list storage unit 23 by using the item IDs in G1 as keys, and set all the customer IDs in the acquired access logs as G2: a group 72 of customers who accessed the items of G1 (primary customers) as shown in FIG. 40 (step 2440).

(6) At the potential customer extraction processing unit 24, similarly as in (5), the access logs for viewing/purchasing of the items made by the customers with the customer IDs in G2 in the past are acquired from the access log list storage unit 23 by using the customer IDs in G2 as keys, and set all the item IDs in the acquired access logs other than those in G1 as G3: a group 73 of items highly related to the items of G1 as shown in FIG. 40 (step 2450).

(7) At the potential customer extraction processing unit 24, similarly as in (5), the access logs for viewing/purchasing of the items with the item IDs in G3 made by the customers in the past are acquired from the access log list storage unit 23 by using the item IDs in G3 as keys, and set all the customer IDs in the acquired access logs other than those in G2 as G4: a group 74 of customers who are potentially likely to have interests in the items of G1 (potential customers) as shown in FIG. 40 (step 2460).

(8) At the potential customer extraction processing unit 24, the customer IDs in G4 are transmitted as the potential customer list to the output unit 26 (step 2470),

(9) Upon receiving the potential customer list, the output unit 26 outputs the potential customer list to an external interface (step 2480).

By the above operation, it is possible to extract a group of customers who have access trends similar to the group of customers who accessed the advertisement target items. This group of customers who have access trends similar to the primary customers can be regarded as having the similar interests as the primary customers so that what is extracted here is the group of customers who are potentially likely to purchase the advertisement target items (potential customers).

In the processing of (4) to (7), it is also possible to improve the accuracy of the similarity in the access trends by determining the priority orders, by the sorting using the number of accessed items in the group (the number of overlapping accesses), the access date and time, the number of items accessed in the past by the customer, the number of customers who accessed the item in the past, etc., as keys for example, and narrowing down the customers or the items in the group to several ones from the top in the sorted order.

<Advertisement Delivery Operation>

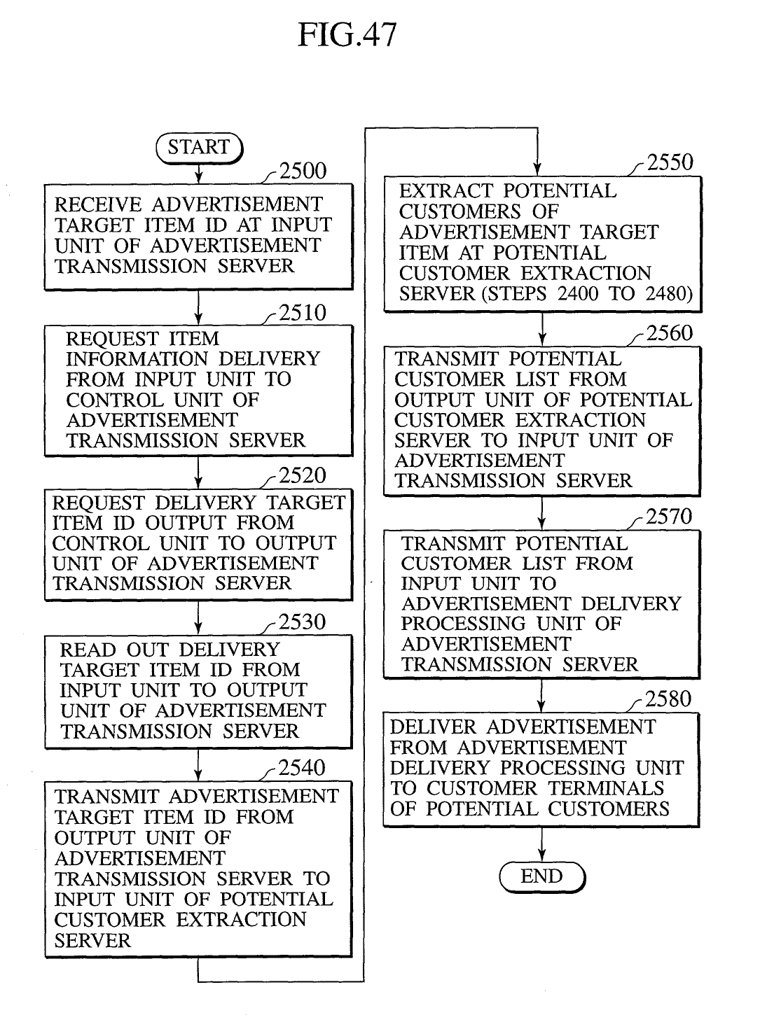

FIG. 47 shows a processing flow for the operation to delivery the advertisement to the potential customers at the advertisement transmission server 30, which proceeds as follows.

(1) At the advertisement transmission server 30, the input unit 33 receives an input of one or a plurality of the advertisement target item IDs along with an “advertisement delivery request” (step 2500).

(2) At the advertisement transmission server 30, the advertisement delivery request is transmitted from the input unit 33 to the control unit 31, and the advertisement delivery operation is started (step 2510).

(3) Upon receiving the advertisement delivery request, the control unit 31 transmits an “advertisement target item ID output request” to the output unit 34 (step 2520).

(4) Upon receiving the advertisement target item ID output request, the output unit 34 reads out the advertisement target item IDs from the input unit 33 (step 2530).

(5) The output unit 34 transmits the advertisement target item IDs along with the “potential customer extraction request” to the potential customer extraction server 20 (step 2540).

(6) At the potential customer extraction server 20, the potential customer extraction operation with respect to the advertisement target items is carried out (step 2550 (steps 2400 to 2480)).

(7) The input unit 33 of the advertisement transmission server 30 receives the potential customer list outputted from the potential customer extraction server 20 (step 2560).

(8) Upon receiving the potential customer list, the input unit 33 of the advertisement transmission server 30 transmits the potential customer list to the advertisement delivery processing unit 32 (step 2570).

(9) Upon receiving the potential customer list, the advertisement delivery processing unit 32 transmits the advertisement to the customer terminals 60 corresponding to the customer IDs described in the potential customer list, by using e-mails, push-type delivery device, or the like (step 2580).

The advertisement delivery method is not necessarily limited to that of direct transmission using e-mails or push-type delivery device, and can be a method in which the banner advertisement is displayed when the customer terminal 60 accesses the on-line shopping server 10.

According to this embodiment, the advertisement delivery target can be narrowed down to the potential customers according to the past access logs of the customers alone, so that the following advantages can be obtained.

There is no need for the registration of the attribute information from the customers in advance (it becomes easier to attract the customers as no time and effort for the attribute input will be required to the customers).

There is no need for the registration of the attribute information for the items (no time and effort will be required for the maintenance).

The advertisement delivery with respect to the potential customers of the advertisement target items can be carried out so that the possibility for the customers to have interests in the advertisement target items can be increased.

Consequently, it is possible to reduce the time and effort required to the customers and the time and effort required for the management, while increasing the possibility of having the advertisement target items viewed/purchased by the customers.

Note that it is also possible to realize the advertisement delivery by displaying a menu in a form of recommended items on a top page of the on-line shopping server 10, for example,

Note also that, apart from the case of utilizing the Internet, this embodiment is effective in determining the advertisement delivery target by using the access logs alone, on media or network in which the attribute input is difficult such as the digital interactive TV network or information technology based home electronics network.

Note also that the on-line shopping server 10, the potential customer extraction server 20, the advertisement transmission server 30 and the charge information management server 40 described above may be provided as separate server devices, or some or all of them may be combined into a single server device.

Note also that the on-line shopping server 10 can be provided in a form of a WWW server, a POS device such as that provided at a convenience store, for example, or a call center of a telephone shopping service.

As described, at the on-line shopping server such as that of the Web EC site, the access log for the viewing of the item information or the purchasing of the items made by the customer is recorded. The recorded information includes “customer ID, item ID, access date and time”, for example.

Such access logs are collected, and as shown in FIG. 40, at a time of delivering the advertisement for an item A, the advertisement is delivered to a group G4 of “customers (potential customers) who are potentially likely to view/purchase a group G1 of items comprising the item A and items related to the item A”, who are accessing a group G3 of “items that are commonly viewed/purchased by a group G2 of customers who viewed/purchased items of the group G1” similarly as the group G2.

In this way, according to this embodiment, it is possible to carry out the advertisement delivery with respect to the customers who are likely to view/purchase the advertisement target items according to the access logs alone. (without requiring the registration of attributes of the customers and the items in advance).

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, various server devices such as the information delivery server, the advertisement providing server, the on-line shopping server, the potential customer extraction server and the advertisement transmission server of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A method for information delivery, comprising the steps of:
managing access logs for accesses to information items made by users;
receiving a correlation detection condition indicating at least one information item from a client;
detecting related users who made accesses to said at least one information item according to the access logs;
extracting correlated information items that are accessed by the related users according to the access logs; and
delivering the correlated information items to the client.

2. The method of claim 1, wherein the extracting step extracts the correlated information items as information items other than the at least one information item indicated by the correlation detection condition that are accessed by the related users.

3. The method of claim 1, wherein the extracting step extracts the correlated information items periodically, and the delivering step delivers the correlated information items periodically.

4. The method of claim 1, wherein the managing step manages the access logs each of which is recorded when viewing/purchasing of an information item is made by a user.

5. The method of claim 1, wherein the detecting step detects the related users as a prescribed number of users who made relatively greater number of accesses to said at least one information item among those users who made accesses to said at least one information according to the access logs.

6. The method of claim 1, wherein the extracting step extracts the correlated information items as a prescribed number of information items that are accessed by the related users for relatively greater number of times among those information items which are accessed by the related users according to the access logs.

7. The method of claim 1, wherein the detecting step detects the related users by selecting selected information items in the correlation detection condition for which a total number of accesses is greater than a prescribed threshold, and selecting a prescribed number of users who made accesses to any of the selected information items earlier than other users who made accesses to any of the selected information items according to the access logs, or selecting those users who made accesses to any of the selected information items within a prescribed period of time, and
the extracting step extracts the correlated information items by selecting those information items that are accessed by the related users within a prescribed period of time.

8. The method of claim 7, wherein the detecting step selects the selected information items from those information items in the correlation detection condition which have a specific attribute, and detects the related users from those users who have a particular attribute, and
the extracting step extracts the correlated information items from those information items that have the specific attribute.

9. The method of claim 8, wherein the specific attribute indicates a specific information item classification, and the particular attribute indicates a particular user type.

10. The method of claim 7, wherein the delivering step delivers the correlated information items in a descending order of a number of times for which each correlated information item is accessed by the related users.

11. The method of claim 7, wherein the delivering step delivers the correlated information items in a descending order of a number of users among the related users who accessed each correlated information item.

12. The method of claim 7, wherein the delivering step delivers the correlated information items in a descending order of a time at which each correlated information item is accessed by at least one of the related users.

13. An information delivery device, comprising:
a unit configured to manage access logs for accesses to information items made by users;
a unit configured to receive a correlation detection condition indicating at least one information item from a client;
a unit configured to detect related users who made accesses to said at least one information item according to the access logs;
a unit configured to extract correlated information items that are accessed by the related users according to the access logs; and
a unit configured to deliver the correlated information items to the client.

14. A computer usable medium having computer readable program codes embodied therein for causing a computer to function as an information delivery server, the computer readable program codes include:
a first computer readable program code for causing said computer to manage access logs for accesses to information items made by users;
a second computer readable program code for causing said computer to receive a correlation detection condition indicating at least one information item from a client;
a third computer readable program code for causing said computer to detect related users who made accesses to said at least one information item according to the access logs;
a fourth computer readable program code for causing said computer to extract correlated information items that are accessed by the related users according to the access logs; and
a fifth computer readable program code for causing said computer to deliver the correlated information items to the client.

15. A method for providing advertisement, comprising the steps of:
managing access logs for accesses made by users with respect to information provided by an information provider, and advertisement information to be provided to a client who is a user accessing target information specified in advance, the advertisement information being associated with additional information that can be accessed by the client from the advertisement information;
adding access logs of advertisement agents who are virtual users accessing both the target information and the additional information, to the access logs; and
providing the advertisement in response to a request from the client, by detecting the advertisement agents as related users who made accesses to the target information besides the client according to the access logs, extracting the additional information as correlated information that is accessed by the related users according to the access logs, and delivering the advertisement information managed in association with the additional information as extracted, to the client.

16. The method of claim 15, further comprising the step of:
detecting other related users who made accesses to the target information besides the client and the advertisement agents according to the access logs;
extracting potential target information that is accessed by the other related users according to the access logs;
adding access logs of other advertisement agents who are virtual users accessing the additional information and the potential target information, to the access logs managed by the managing step; and
providing the advertisement with respect to other clients who accessed the potential target information, by detecting the other advertisement agents as other related users who made accesses to the potential target information besides the other clients according to the access logs, extracting the additional information as correlated information that is accessed by the other related users according to the access logs, and delivering the advertisement information managed in association with the additional information as extracted, to the other clients.

17. The method of claim 15, wherein the providing step delivers the advertisement information in a form of being linked to the additional information.

18. The method of claim 15, wherein the managing step manages the advertisement information, the additional information and the target information as specified by an advertisement sponsor.

19. The method of claim 15, further comprising the steps of:
counting an advertisement information delivery count and an additional information access count resulting from an actual advertisement providing operation; and
charging an advertisement fee to an advertisement sponsor according to the advertisement information delivery count and/or the additional information access count.

20. The method of claim 15, further comprising the steps of:
charging an advertisement fee for a minimum advertisement information delivery count and/or a minimum additional information access count that are guaranteed to an advertisement sponsor such that the advertisement sponsor pays the advertisement fee in advance to an actual advertisement providing operation;
counting an advertisement information delivery count and an additional information access count resulting from the actual advertisement providing operation; and
extending an advertisement posting period for carrying out the actual advertisement providing operation until the advertisement information delivery count and/or the additional information access count reach to the minimum advertisement information delivery count and/or the minimum additional information access count.

21. The method of claim 15, further comprising the steps of:
charging an advertisement fee for a minimum advertisement information delivery count and/or a minimum additional information access count that are guaranteed to an advertisement sponsor such that the advertisement sponsor pays the advertisement fee in advance to an actual advertisement providing operation;
counting an advertisement information delivery count and an additional information access count resulting from the actual advertisement providing operation for a prescribed advertisement posting period; and
refunding at least a part of the advertisement fee corresponding to a difference of the advertisement information delivery count and/or the additional information access count with respect to the minimum advertisement information delivery count and/or the minimum additional information access count.

22. An advertisement providing device, comprising:
a unit configured to manage access logs for accesses made by users with respect to information provided by an information provider, and advertisement information to be provided to a client who is a user accessing target information specified in advance, the advertisement information being associated with additional information that can be accessed by the client from the advertisement information;
a unit configured to add access logs of advertisement agents who are virtual users accessing both the target information and the additional information, to the access logs; and
a unit configured to provide the advertisement in response to a request from the client, by detecting the advertisement agents as related users who made accesses to the target information besides the client according to the access logs, extracting the additional information as correlated information that is accessed by the related users according to the access logs, and delivering the advertisement information managed in association with the additional information as extracted, to the client.

23. A computer usable medium having computer readable program codes embodied therein for causing a computer to function as an advertisement providing server, the computer readable program codes include:
a first computer readable program code for causing said computer to manage access logs for accesses made by users with respect to information provided by an information provider, and advertisement information to be provided to a client who is a user accessing target information specified in advance, the advertisement information being associated with additional information that can be accessed by the client from the advertisement information;
a second computer readable program code for causing said computer to add access logs of advertisement agents who are virtual users accessing both the target information and the additional information, to the access logs; and
a third computer readable program code for causing said computer to provide the advertisement in response to a request from the client, by detecting the advertisement agents as related users who made accesses to the target information besides the client according to the access logs, extracting the additional information as correlated information that is accessed by the related users according to the access logs, and delivering the advertisement information managed in association with the additional information as extracted, to the client.

24. A method for providing advertisement, comprising the steps of:
managing access logs for accesses to information items made by users;
detecting primary users who made accesses to an advertisement target information item or information items related to the advertisement target information item according to the access logs;
extracting related information items that are accessed by the primary users according to the access logs;
determining potential users who made accesses to the related information items according to the access logs; and
delivering the advertisement target information item to the potential users.

25. The method of claim 24, wherein the extracting step extracts the related information items as information items other than the advertisement target information item or information items related to the advertisement target information item, that are accessed by the primary users according to the access logs, and
the determining step determines the potential users as users other than the primary users, who made accesses to the related information items according to the access logs.

26. The method of claim 24, wherein the managing step manages the access logs each of which is recorded when viewing/purchasing of an information item is made by a user.

27. The method of claim 24, wherein the managing step manages the access logs each of which indicates at least an accessing user ID and an accessed information item ID.

28. The method of claim 24, further comprising the step of:
generating a potential user list in which the potential users are arranged in an order according to the access logs of the potential users,
wherein the delivering step delivers the advertisement target information item to the potential users according to the potential user list.

29. The method of claim 28, wherein the delivering step delivers the advertisement target information item only to a prescribed number of the potential users according to the potential user list.

30. The method of claim 24, wherein the delivering step delivers the advertisement target information item by sending an advertisement message to the potential users through a network.

31. The method of claim 24, wherein the delivering step delivers the advertisement target information item by displaying a banner advertisement for the advertisement target information item in response to an access from any of the potential users.

32. The method of claim 24, further comprising the step of:
charging an advertisement fee to an advertisement sponsor of the advertisement target information item.

33. The method of claim 32, wherein the charging step charges the advertisement fee at a meter rate according to an advertisement delivery count.

34. The method of claim 32, wherein the charging step charges the advertisement fee at a flat rate guaranteeing a prescribed advertisement delivery count.

35. The method of claim 32, wherein the charging step charges the advertisement fee at a meter rate according to an advertisement response count.

36. The method of claim 32, wherein the charging step charges the advertisement fee at a flat rate guaranteeing a prescribed advertisement response count.

37. An advertisement providing device, comprising:
a unit configured to manage access logs for accesses to information items made by users;
a unit configured to detect primary users who made accesses to an advertisement target information item or information items related to the advertisement target information item according to the access logs;
a unit configured to extract related information items that are accessed by the primary users according to the access logs;
a unit configured to determine potential users who made accesses to the related information items according to the access logs; and
a unit configured to deliver the advertisement target information item to the potential users.

38. A computer usable medium having computer readable program codes embodied therein for causing a computer to function as an advertisement providing server, the computer readable program codes include:
a first computer readable program code for causing said computer to manage access logs for accesses to information items made by users;
a second readable program code for causing said computer to detect primary users who made accesses to an advertisement target information item or information items related to the advertisement target information item according to the access logs;
a third computer readable program code for causing said computer to extract related information items that are accessed by the primary users according to the access logs;
a fourth computer readable program code for causing said computer to determine potential users who made accesses to the related information items according to the access logs; and
a fifth computer readable program code for causing said computer to deliver the advertisement target information item to the potential users.
